(19) United States
(12) Patent Application Publication
(10) Pub. No.: US 2020/0049130 A1
(43) Pub. Date: Feb. 13, 2020

(54) Electrical Power Generator

(71) Applicant: Vortex Bladeless, S.L., Madrid (ES)

(72) Inventor: David Jesús Yáñez Villarreal, Ávila (ES)

(21) Appl. No.: 16/342,802

(22) PCT Filed: Feb. 15, 2018
(86) PCT No.: PCT/EP2018/053839

§ 371 Date: Apr. 17, 2019

(30) Foreign Application Priority Data
Feb. 17, 2017 (EP) 17382079.6

(51) Int. Cl. F03D 9/25; H02K 7/18; F03D 3/00

(52) U.S. Cl. CPC F03D 9/25; F03D 3/005; H02K 7/1892

(57) ABSTRACT

An electrical power generator comprises a capturing element (1) attached to a base (1000) in correspondence with a first end (11) thereof. The capturing element is located in a fluid and configured such that, when the fluid moves, the capturing element generates vortices in the fluid which produce an oscillating movement of the capturing element (1). The capturing element (1) has a cross section with a characteristic dimension, which decreases from a first longitudinal position (11A) located closer to the first end (11) than to a second end (12) until a second longitudinal position (12A) located closer to the second end (12) than the first longitudinal position (11A).

### TECHNICAL FIELD

The invention pertains to the field of renewable energies and more specifically to the field of electrical power generation based on the von Karman vortices.

### BACKGROUND OF THE INVENTION

Due to the drawbacks of non-renewable energies, such as those based on the combustion of fossil fuels or nuclear energy, major efforts have been made to develop so-called renewable energies such as solar and wind power.

Although the maybe most wide-spread wind power generator is the multi-blade horizontal axis wind turbine, some alternatives are being developed. For example, FR-2922607-A1 discloses examples of wind power generators based on structures arranged to move due to the wind gusts that affect the structures, whereby the moving structures generate electricity by acting on piezoelectric elements.

Other wind power generators make use of the so-called von Karman vortices (also called Karman vortices). An example of a wind power generator based on the principle of a capturing element that oscillates due to the von Karman vortices is disclosed in EP-2602483-A1. Another example is disclosed in WO-2014/135551-A1. Here, the oscillating movement of a pole is converted into electrical energy by piezoelectric systems. It is further explained how the natural frequency of oscillation of the pole can be modified by applying a voltage to a piezoelectric material that surrounds an elastic core of the pole.

An advantage with this type of generator based on the Karman vortices is that it can operate without bearings, gears and lubricants and that it does not require additional means for starting up the generator.

The use of piezoelectric elements could seem to be an ideal solution for converting an oscillatory and non-rotational movement—such as the movement naturally generated by the Karman vortices—into electricity. However, there are also other options. For example, WO-2016/055370-A2 describes a generator based on the Karman vortices that uses magnets and coils to produce electrical energy out of the oscillatory movement of a pole.

WO-2016/055370-A2 describes an electrical power generator comprising a pole configured to deliberately transform a stationary and laminar flow of air into a turbulent flow, wherein eddies or vortices appear in a synchronised manner throughout the length of the pole. Therefore, the pole sustains two forces, namely, a drag force in the same direction as the wind and a lift force produced in a direction perpendicular to the direction of the wind, the direction of which changes sign, with a frequency that corresponds to the frequency of the appearance of new vortices and which can be calculated using the following formula:

$${F}_{V} = \frac{S \cdot V}{d}$$

where F_{V} is the frequency of appearance of vortices, V the velocity of the air, S is Strouhal's dimensionless number and d the characteristic dimension of the pole, for example, in the case of a pole having a circular cross-section, the diameter of the pole.

In order to maximise the energy capture of the capturing element, it may be desirable for the vortices to appear in a synchronised manner along the capturing element. Given that the wind speed, according to the Hellmann exponential Law, increases with height and given that the frequency of the appearance of vortices depends on both the relative velocity between air and capturing element (which in turn depends on wind speed) and on the characteristic dimension of the capturing element (in this case, on its diameter), it has traditionally been considered that it is appropriate for the diameter of the capturing element to increase with height, as explained in for example EP-2602483-A1. One more reason for an increasing diameter of the capturing element in the axial direction from a first end (where the capturing element is attached to a base) towards a second end (the free end, where the amplitude of the oscillation is at its maximum) could be the fact that the velocity of the oscillatory movement of the capturing element increases with the distance from the base.

WO-2016/055370-A2 explains how a capturing element can be designed with a diameter that increases with the distance from the base, in order to allow for synchronisation of the vortices all throughout the height of the capturing element. However, it has been found that this kind of design may in fact turn out to be suboptimal.

### DESCRIPTION OF THE INVENTION

A first aspect of the invention relates to an electrical power generator comprising a capturing element and a subsystem for converting the oscillating movement of the capturing element into electrical energy.

The capturing element has an elongated shape and extends in a longitudinal direction between a first end of the capturing element and a second end of the capturing element. The capturing element has a cross section with a characteristic dimension and a length between the first end and the second end.

The capturing element is configured to be attached to a base and submerged in a fluid with the first end closer to the base than the second end. The capturing element is further configured such that, when the fluid moves, the capturing element generates vortices in the fluid so that an oscillating lift force is generated on the capturing element, which produces an oscillating movement of the capturing element.

In accordance with this aspect of the invention, the characteristic dimension decreases from a first longitudinal position located closer to the first end than to the second end until a second longitudinal position located closer to the second end than the first longitudinal position. That is, contrary to what is suggested in EP-2602483-A1 and WO-2016/055370-A2 regarding the variation of the characteristic dimension (such as the diameter) along the capturing element, in accordance with the first aspect of the present invention the characteristic dimension decreases in the longitudinal direction at least in correspondence with a portion of the capturing element that begins closer to the first end than to the second end and that actually may extend over most of the axial/longitudinal extension of the capturing element.

This geometry has surprisingly been found to be advantageous, because it is better adapted to the actual generation of the vortices than the geometry of capturing elements known from EP-2602483-A1 and WO-2016/055370-A2. Thus, the capturing element may be shaped for generation of von Karman vortices in a substantially synchronised manner along the capturing element, for adequate or enhanced performance, efficiency and/or productivity.

The capturing element is configured to be located in a fluid, for example, in the air, although there are also other possibilities, such as water. The fluid may have a substantially stationary and laminar flow, a characteristic that is normally present in the wind. The capturing element is configured such that, when the fluid moves, it generates vortices in the fluid in such a way that an oscillating lift force is generated on the capturing element which produces an oscillating movement of the capturing element as described in, for example, WO-2016/055370-A2. This phenomenon is well known in the art. Without being bound by theory, this feature may for example be achieved by the shape of the capturing element: if a blunt object such as a cylinder is submerged in a laminar airflow, vortices will appear for a high range of airspeed values.

In normal operation, the capturing element is attached to the base, the first end of the capturing element being closer to the base than the second end.

The known formula for the calculation of the frequency of the appearance of new vortices may be used in a point where the oscillation of the capturing element is almost zero. In some particular embodiments, the first end of the capturing element is arranged to coincide with this point, as taught by WO-2016/055370-A2. This can serve to optimize the energy capture, since if the capturing element were extended beyond this point, the oscillation movement of the bottom part of the capturing element would create vortices in the opposite sense, which would negatively affect the energy capture. Thus, calculations for optimized energy capture can be based on a situation in which the first end of the capturing element is a point where oscillation is almost zero.

At this first end of the capturing element, the characteristic dimension will be referred to as d, and estimated wind speed will be referred to as v₁. According to the formula referred to above, the frequency of appearance of new vortices at the first end (and without taking into account any special end effects) will thus be

$$f = \frac{St \cdot {v}_{1}}{d}$$

If this frequency is calculated for a generic point of the capturing element, and a design criterion is imposed according to which this frequency shall be equal along the whole capturing element, the following expression is obtained:

$$\frac{St \cdot {v}_{1}}{d} = \frac{St \cdot v ( y )}{φ ( y )}$$

wherein v(y) is the wind speed at a generic point located at a distance y from the first end, and ϕ(y) is the equivalent characteristic dimension of the capturing element at this point.

Without being bound by theory, this equivalent characteristic dimension may be expressed as a function of the characteristic dimension D(y) of the capturing element at this point when it does not move, and a contribution due to oscillation, in the following way:

$$φ ( y ) = D ( y ) + {k}_{1} \cdot \frac{y}{H} \cdot d$$

Wherein H is the length of the capturing element (that is, the distance between its first end and second end) and k₁ is a constant which relates the influence of the amplitude of the oscillation to the distance from the point to the first end. It depends on the maximum amplitude of this oscillation.

At the first end the amplitude of the oscillation is zero, so d is at the same time the characteristic dimension and the equivalent characteristic dimension of the capturing element at the first end.

If the expression of ϕ(y) is introduced into the first equation, the variation of the characteristic dimension of the capturing element in the axial direction will be given by the following non-dimensional expression:

$$\frac{D ( y )}{d} = \frac{v ( y )}{{v}_{1}} - {k}_{1} \cdot \frac{y}{H}$$

This expression includes two terms with opposed signs. Depending on the expression used for the estimation of v(y), D(y) will grow or decrease along the length of the capturing element. However, for standard values, it may be shown that there is a first longitudinal position closer to the first end than to the second end where the characteristic dimension is greater than at a second longitudinal position located closer to the second end than the first longitudinal position.

For example, if we use the Hellmann's exponential law for wind speed

$$\frac{v ( y )}{{v}_{1}} = \frac{v ( y )}{{v}_{1}} \cdot \frac{{v}_{10}}{{v}_{10}} = \frac{v ( y )}{{v}_{10}} \cdot \frac{{v}_{10}}{{v}_{1}} = {( \frac{y + {y}_{0}}{10} )}^{α} \cdot {( \frac{10}{0 + {y}_{0}} )}^{α} = {( \frac{y}{{y}_{0}} + 1 )}^{α}$$

where y₀ is the distance between the first end of the capturing element and the base.

Accordingly, the following expression of the characteristic dimension is obtained:

$$\frac{D ( y )}{d} = {( \frac{y}{{y}_{0}} + 1 )}^{α} - {k}_{1} \cdot \frac{y}{H}$$

If usual values, such as α=0.15, y₀=0.35 metres, H=1 metre and k₁=0.45 are used, the expression of D(y)/d decreases with y from y=0 to y=H, so the first longitudinal position will coincide with the first end and the second longitudinal position will coincide with the second end. In some embodiments, a may be comprised between 0.05 and 0.25. In some embodiments, y₀ may be comprised between 0.05 and 10 metres. In some embodiments, H may be comprised between 0.5 and 8 times y₀. In some embodiments, k₁ may be comprised between 0.3 and 0.55. In some embodiments, a is comprised between 0.05 and 0.18, y₀ is comprised between 0.2 and 2 metres, H is comprised between 2 and 5 times y₀ and k₁ is comprised between 0.325 and 0.5. Just as an example, if the Hellmann law were used for modelling wind speed, the electrical power generator of the invention would work optimally while

k₁>α·p·(1+0.5·p)^{α-1}

This last equation is not a condition for the operation of the generator, but just a condition between some design parameters that should be met when a particular law is used for modelling the wind speed along the height of the capturing element. However, several different laws may be used to model the wind speed around the generator.

Depending on these parameters, in some particular embodiments, the distance between the first longitudinal position and the second longitudinal position is greater than 30% of the length of the capturing element, such as greater than 40%, 50%, 60%, 70%, 80%, 90%, 95% or 99%. In some embodiments, this distance corresponds to the full length of the capturing element, that is, to the distance between the first end and the second end. That is, in some embodiments, the characteristic dimension (that is, the diameter if the capturing element has a circular cross section) constantly decreases in the axial direction from the first end to the second end, or throughout most of the length of the capturing element. However, the rate at which it decreases may vary, for example, for reasons that will be explained below when discussing possible terminations of the capturing element in correspondence with the second end.

Depending on these parameters, in some particular embodiments, the distance between the first longitudinal position and the first end is less than 30% of the length of the capturing element, such as less than 20%, less than 10% or less than 5%. In some embodiments, the first longitudinal position coincides with the first end of the capturing element.

Thus, it has been found that contrary to what appears to have been the common belief in the field in recent years, rather than using a capturing element the characteristic dimension of which generally increases with height (or with the axial position from the first to the second end), it can actually often be preferred to use a capturing element the characteristic dimension of which decreases in the axial direction during all or most of the trajectory from the first end to the second end, the decrease staring closer to the first end than to the second end, often close to the first end such as at the first end. These teachings thus represent a useful tool for the design and production of more effective and/or efficient vortex based wind power generators.

One advantage of these arrangements is that they allow for a relatively substantial characteristic dimension (such as the diameter) of the capturing element at the axial position where the subsystem for energy conversion is placed, for example, inside the capturing element somewhere between the first and the second end, such as somewhere closer to the first end than to the second end but preferably closer to the centre than to the first end and to the second end, so as to allow for a relatively substantial size of the subsystem including the energy converting means (including, for example, magnets and coils) while at the same time allowing for a relatively substantial amplitude of oscillation, such as in the order to 1 to 1.4 times D, where D is the characteristic dimension close to the second end, such as in correspondence with the cover point to be discussed below.

The design described above does not take into account that when a capturing element is submerged into a laminar airflow, some upper vortices appear near the second end of the capturing element. These upper vortices distort the desired vortices, i.e., the vortices that contribute to the oscillatory movement of the capturing element.

It has been found that if the termination of the capturing element in correspondence with the second end is designed so that the characteristic dimension of the capturing element decreases in the zone from a cover point to the second end of the capturing element, in such a way that the decrease rate decreases at least once in the direction from the cover point to the second end, performance of the electrical power generator can be enhanced. The expression “cover point” is used herein to refer to a point relatively close to the second end, typically at a distance from the second end corresponding to less than 20%, 15% or 10% of the length of the capturing element and/or typically featuring an increase in the decrease rate. That is, the cover point refers to the axial or longitudinal position of the capturing element where a termination of the capturing element can be perceived, for example, by a more or less substantial increase in the decrease rate of the characteristic dimension in the direction towards the second end. The term “cover point” has been used because the termination of the capturing element can typically comprise placing a separately manufactured cover or cap portion onto the rest of the capturing element.

Without being bound by any specific theory, it appears that this configuration of the capturing element in correspondence with its second end reduces the size of these upper vortices, thus reducing the negative influence of these upper vortices. Thus, this kind of reduction of the characteristic dimension contributes to enhancing the efficiency with which the capturing element captures energy from the wind, for example, since reducing the upper vortices reduces the interferences that these upper vortices cause on the vortices that create the oscillating lifting forces. The more the effect of these non-desired vortices on the desired vortices is reduced, the better the performance of the electrical power generator.

This reduction in the characteristic dimension (such as in the diameter) comprises at least one zone where the decrease rate decreases in the direction from the first end to the second end. The decrease rate is the derivative of the size of the characteristic dimension with respect to the y coordinate:

$$decrease rate = \frac{\partial D ( y )}{\partial y}$$

The fact that this decrease rate decreases at least once means that there is an upper point of the curve D(y) where the decrease rate is lower than the decrease rate at a lower point of the curve D(y), the lower point being closer to the first end of the capturing element than the upper point.

That is, instead of a simple straight cut end of the capturing element after reaching the cover point, or the kind of termination with a very rapidly and constantly increasing decrease rate as known from for example, WO-2016/055370-A2, WO-2014/135551-A1, EP-2602483-A1, or US-2008/048455-A1, many embodiments of the present invention feature at least one reduction of the decrease rate between the cover point and the second end.

This termination of the capturing element in correspondence with the second end can be embodied in different ways, for example, by a convex section—that is, a section where the longitudinal cross section of the capturing element is convex towards the exterior—followed by a concave section, or by embodiments where one or more conical or frustoconical (or pyramidal or frustopyramidal) sections follow each other, where the decrease rate is smaller in at least one cone or frustocone (or pyramid or frustopyramid) closer to the second end than in one further away from the second end.

In some embodiments, the distance between the first end and the cover point is less than 95% of the length of the capturing element. This embodiment ensures that a sufficient part of the capturing element is available for minimizing the generation of upper vortices near the second end, by featuring a decrease in the characteristic dimension as explained above. In some embodiments, the distance between the first end and the cover point is less than 90% of the length of the capturing element.

In some embodiments, the cross section of the capturing element is substantially circular and the cross section has a diameter, and the characteristic dimension is the diameter.

In other embodiments, the capturing element does not have a circular cross section, but a cross section with a different shape, for instance, the shape of a polygon with or without rounded vertices. Accordingly, the explanations and formulae set out in the present specification are likewise valid for these embodiments, but in these cases, the concept “characteristic dimension” should be understood as the diameter of a circle with the same surface as the cross section of these embodiments. Although this invention may be carried out with a capturing element having differently shaped cross sections, many embodiments will have a circular cross section.

In a particular embodiment, the capturing element comprises, between the cover point and the second end,

a first portion wherein the decrease rate is either constant or increases in the direction from the first end towards the second end, and

a second portion, which is closer to the second end than the first portion, wherein the decrease rate is

either constant and lower than the decrease rate at the first portion; or

decreases in the direction from the first end towards the second end.

In some embodiments, this division of the upper zone of the capturing element into two portions—the upper zone is the zone between the cover point and the second end—can help to simplify the manufacturing, for example, since each portion of the upper zone of the capturing element may be manufactured separately and then joined together. Also, for example, in some embodiments each portion can be manufactured having a specific decrease rate. In the event of each portion being a frustocone (or one being a frustocone and the other one a cone), this feature may be particularly advantageous, for example, from the point of view of ease of manufacture. Of course, in some embodiments, the zone between the cover point and the second end may comprise more than two portions, of which at least two comply with the relation between decrease rates set out above.

In some embodiments, the first portion is convex towards the exterior and the second portion is concave towards the exterior.

These particular embodiments ensure a silhouette for the upper zone with soft transitions.

In some embodiments, the electrical power generator further comprises a support element such as, for example, a flexible rod or pole, with a first attaching point and a second attaching point, wherein

the first attaching point is a point of the support element where the electrical power generator is intended to be attached to the base, and

the second attaching point is a point of the support element where the support element is attached to the capturing element.

The first attaching point is intended to be attached to the base so that, in normal operation, this first attaching point does not oscillate with the rest of the electrical power generator. However, it is not necessary that this first attaching point is an end of the support element, as the support element may have a portion buried under the base.

The second attaching point is where the support element is attached to the capturing element, this attachment being a clamped attachment. This clamped attachment may be obtained in different ways. In some embodiments, auxiliary attaching points are arranged, to avoid angular degrees of freedom in the second attaching point. Hence, in some embodiments, the support element may continue upwards after the second attaching point but the second attaching point is the lowest point of clamped attachment between the support element and the capturing element.

The capturing element is, in many embodiments, relatively rigid and does not deform during the oscillating movement. Thus, the capturing element can be designed and arranged so that the lift force acts on the capturing element, and the support element is in some embodiments more flexible and/or more elastic than the capturing element and is arranged to connect the capturing element to the base, so that when the lift force acts on the capturing element, the capturing element will sway with regard to said base, for example, due to elastic deformation of the support element. This arrangement can provide for a reduction of costs as a less costly material can be used for the capturing element than for the support element, and the support element can be designed to make sure that the displacement or swaying of the capturing element will be enough to produce electrical power via the subsystem, while being resistant enough to withstand the forces generated by the wind and by the swaying of the capturing element, for a long time including periods with high wind speeds. Regarding the capturing element, what is primarily important is often its shape and size, in combination with a sufficiently low weight and sufficient resistance to wear, including weather-induced wear. Thus, using two parts with different characteristics in what regards, for example, elasticity, can be an advantage and helpful to reduce costs. The support element may be made of a different material or of different materials than the capturing element, or if made of the same materials, it may comprise them in proportions different from the proportions used for the capturing element. The capturing element is preferably made of a light-weight material and can be substantially hollow.

For example, the capturing element can preferably be made of, or at least comprise, lightweight materials such as, for example, carbon fibre, fibreglass, polyester resin, epoxy resin, basalt fibres, balsa wood, aluminium and/or titanium, etc. This capturing element may include internal reinforcing elements such as ribs, brackets or beams that provide structural rigidity. In some embodiments, the capturing element has a length of more than 10 cm, such as more than 0.5 m or more than 1 m, such as more than 2 m or 4 m or 10 m or 20 m or 50 m or 100 m or 150 m or 200 m. The support element, such as a rod, can be made of any material suitable for providing an appropriate performance. Carbon fiber or metals such as titanium and steel are examples of suitable materials.

In the present application, the term “base” will refer to the point with respect to which oscillation takes place, that is, the point of “fixed attachment”. For example, if the electrical power generator comprises the capturing element and a support element and the capturing element is attached to a base via the support element, the place of insertion of the support element into a fixed and/or rigid structure will be considered as the base.

The term “support element” should not be interpreted in a restrictive sense and should especially not be interpreted as necessarily referring to one single element; the elastic element can for example comprise several elements arranged in any suitable manner in relation to each other.

The term “elastic” refers to the elastic character of the element in the sense that after deformation by bending it tends to return to its original shape. The term “elastic” is not intended to imply any need for elastic character in terms of its performance after elongation.

In some embodiments, the distance between the first end of the capturing element and the second end of the capturing element is greater than the distance between the second attaching point of the support element and the second end of the capturing element, the capturing element thus comprising a skirt, which is a hollow portion that extends between the first end of the capturing element and the second attaching point.

This arrangement allows the capturing element to absorb more energy: not only from the second attaching point of the support element upwards, but also from the second attaching point and downwards, since the portion of the capturing element that extends downwards from the second attaching point is also available for obtaining energy from the fluid such as air.

In some embodiments, the distance between the first end of the capturing element and the second attaching point of the support element is the same as the distance between the first end of the capturing element and the first attaching point of the support element.

In some embodiments, and considering an air speed profile v(y), the size of the characteristic dimension is defined by the following formula:

$$\frac{D ( y )}{d} = \frac{v ( y )}{{v}_{1}} \cdot g ( y ) - {k}_{1} \cdot \frac{y}{H}$$

wherein

v(y) is the airflow speed profile in the y direction, according to a standard wind speed gradient;

y is the coordinate measured from the first end of the capturing element, in the direction towards the second end of the capturing element;

D(y) is the size of the characteristic dimension of the cross section of the capturing element;

g(y) is a sigmoid function; and

H is the height of the electrical power generator as defined above.

There are several standard wind speed gradients. Some of them are exponential laws, such as the Hellmann exponential law, but other methodologies may also be used in different embodiments, such as the Monin-Obukhov method.

There are several sigmoid functions which may be suitable for achieving a shape which is adequate for the electrical power generator of the invention. In a particular embodiment,

$$g ( y ) = \frac{1}{1 + {e}^{- τ}}$$

$$wherein$$

$$τ = \frac{\frac{2 K}{p} \cdot ( H - y )}{H - L / 2} - K$$

K>4, and p<0.3.

K is a parameter that which is related to the value of y where g(y)≈0; and

p is a parameter that represents the portion of the capturing element which is affected by this shape, wherein p=0 for no affection and p=1 for total affection.

As may be inferred from this formula, the sigmoid function is not the function that defines the shape of the upper zone of the capturing element. This sigmoid function has been chosen because, according to experimental measurements, it fits the effect on the relative speed caused by the upper vortices which are produced by the wind at the second end of the capturing element. When this sigmoid function has been introduced in the formula of the relative speed, this gives rise to an expression of the characteristic dimension, which also includes this sigmoid function.

In some embodiments, the capturing element is at least partially hollow, and the subsystem for converting the oscillating movement of the capturing element into electrical energy is at least partially housed inside the capturing element. In some embodiments, the subsystem is completely housed within the capturing element.

It has been found that there can be many advantages involved with placing a subsystem for converting the movement of the capturing element into electrical energy at least partially within the capturing element. One of these advantages is that it provides for a compact arrangement of the energy conversion means. In order to maximise energy capture while minimizing material costs and weight, the capturing element is advantageously a substantially hollow part. Arranging the subsystem for converting movement of the capturing element into electrical energy at least partially within the capturing element provides for a compact and elegant arrangement, for example, in the form of an elongated pole, without a potentially bulky subsystem for converting mechanical energy into electrical energy surrounding its base, as in the prior art systems known from WO-2012/066550-A1, US-2008/0048455-A1, and WO-2014/135551-A1.

In some embodiments, the second end is at a distance H (corresponding to the length of the capturing element) from the first end, such as at a height H above the first end, and the subsystem is placed at a distance of more than 0.05H from the first end, preferably at a distance of more than 0.1H from the first end, even more preferably at a distance of more than 0.2H, such as at a distance of more than 0.3H or more than 0.4H, from the first end, and optionally at a distance of at least 0.1H below or from the second end, such as at a distance of more than 0.2H, more than 0.3H or more than 0.4H from the second end. For example, in some embodiments the subsystem is placed at a distance of more than 0.1H above the first end and more than 0.1H below the second end, such as at a distance of more than 0.2H above the first end and more than 0.2H below the second end, for example, towards the longitudinal centre portion of the capturing element, for example, at a distance of more than 0.3H above the first end and more than 0.3H below the second end. In other embodiments, the subsystem can be positioned close to the first end (such as in the bottom 10% or 20% of the longitudinal extension of the capturing element), and in other embodiments it can be placed at the second end or close to it (such as in the upper 10% or 20% of the longitudinal extension of the capturing element). It has been found that it can be preferred that the subsystem is placed within a range of between 0.25H and 0.5H from the first end, to provide for an appropriate balance of amplitude of oscillation and lever effect while avoiding an interference between moving parts, as will be further discussed below. Also, sometimes it can be preferred to have magnets and/or other relatively heavy components placed at a substantial distance from or below the second end, such as more than 0.3H or more than 0.5H from the second end.

In some embodiments, the first end is above the base. In other embodiments, the first end is below the base. In some embodiments, the capturing element and/or the subsystem for converting the oscillating movement of the capturing element into electrical energy is/are placed a distance above the base that corresponds to between 5% and 40%, such as between 10% and 30%, of the longitudinal extension of the capturing element, that is, of the distance between the first end and the second end of the capturing element.

Placing the subsystem at a substantial distance from the base and preferably also at a substantial distance from the first end of the capturing element (such as at a distance of 0.1H, 0.2H, 0.3H or 0.4H or more from the first end) may imply a substantial amplitude and maximum velocity of the oscillating movement where the subsystem is placed, which can provide for a correspondingly substantial amplitude and velocity of the relative movement between parts of the subsystem, such as between magnets and coils, thereby enhancing performance of the subsystem in terms of efficient energy conversion. In some embodiments, it is however preferred that the subsystem is placed at a certain distance from the second end of the capturing element, as the amplitude of the movement in correspondence with the second end can make it difficult or impossible to avoid collision between, for example, the inner walls of the capturing element and the subsystem or the structure supporting the subsystem. This may especially be the case when the capturing element is as described above, that is, with a characteristic dimension such as a diameter that decreases towards the second end, for example, with the height: this may cause the space available inside the capturing element to be reduced in the direction towards the second end, whereas the amplitude of the oscillation increases towards the second end.

For many energy conversion systems, for example, for a conversion system based on an interaction between magnets and coils, both amplitude and velocity can be important to provide for efficient conversion of the energy represented by the movement of the capturing element into electrical energy. Thus, placing for example magnets and coils away from the base can be advantageous in terms of efficient energy conversion. For example, when the conversion takes place due to relative movement between magnets and coils, a high velocity can be preferred as the electromotive force induced in a coil is proportional to the change in the magnetic field traversing the coil.

In some embodiments of the invention, the electrical power generator further comprising a subsystem support extending (from, for example, the base) in an axial direction, and the subsystem comprises at least one first subsystem component and at least one second subsystem component arranged for the production of electrical power by movement of the first subsystem component in relation to the second subsystem component, wherein the first subsystem component is attached to the capturing element and the second subsystem component is attached to the subsystem support, so that the oscillating movement of the capturing element produces an oscillating movement of the first subsystem component in relation to the second subsystem component. That is, part of the subsystem can for example be placed on a relatively fixed and static structure within the capturing element, for example, on some kind of tubular or tower structure, whereas another part of the subsystem can be fixed to the capturing element, whereby the oscillating movement of the capturing element will cause the two parts of the subsystem to move in relation to each other. This movement can be used to generate electrical power, for example, by operating an alternator.

In some embodiments, at least one of the first subsystem component and the second subsystem component comprises at least one magnet and at least another one of the first subsystem component and the second subsystem component comprises at least one coil, arranged so that the oscillating movement generates an electromotive force in the at least one coil by relative displacement between the at least one magnet and the at least one coil. The oscillating movement of the capturing element results in a variation in the magnetic field to which the coil or coils are exposed, whereby the oscillating movement of the capturing element is converted into electrical energy.

As the efficiency of power conversion is related to the velocity of change in the magnetic field passing through the coil, the relatively high velocity of the relative movement between magnet or magnet assemblies and coil or coils that is achieved due to the fact that the subsystem is placed at a substantial axial distance from the base and/or from the first end, enhances the performance of the electrical power generator.

Any suitable configuration of magnets and coils can be used. It is sometimes preferred that the coil or coils is/are part of the second subsystem component, as this sometimes can facilitate extraction of the electrical current without any cables or similar having to be attached to the oscillating capturing element. That is, arranging the coils on the preferably static subsystem support can be advantageous as the connections to an external electric system can be made without connection to the capturing element, which is arranged to oscillate. If the coils are in the capturing element, the conductors evacuating the energy may be exposed to degradation by fatigue and the viscous losses may be unnecessarily increased.

Thus, in many embodiments, the first subsystem component comprises one or more magnets, for example, arranged in a plane above and below the coil or coils, whereas the second subsystem component comprises one or more coils. The magnets can be arranged forming rings of magnets above and below the coil or coils. Thus, for example, rings of magnets can be arranged in two or more planes, and one or more for example ring-shaped coils can be provided in one or more planes between the planes determined by the rings of magnets.

In some embodiments, the at least one coil comprises at least two coils arranged in a common plane and surrounding an axis of the capturing element in its neutral position, one of the coils being external to the other one of the coils, the two coils being connected in series so that when current circulates in a clockwise direction through one of the coils, current circulates in a counter-clockwise direction through the other one of the coils, and vice-versa. For example, two coils can be arranged in a plane perpendicular to the vertical axis, and magnets such as annular magnets can be placed in two adjacent planes, so that the two coils are sandwiched between the planes with the magnets. The annular magnets can be arranged so that during oscillation, when the capturing element oscillates in one direction, one portion of the magnets pass above/below the external one of the coils, and the diametrically opposed part of the magnets pass above/below the internal one of the coils, so that due to the interconnection of the coils, both portions of the magnet contribute to enhancing the current flowing through the coils. In some embodiments, only one coil is present in each plane, or a plurality of individual coils are used that are not interconnected as explained above.

It can be advantageous to provide ferromagnetic material in correspondence with the magnets, for example, in correspondence with the annular magnets, including for example ferromagnetic material arranged radially outside the magnets, in order to orient the magnetic field in a desired direction. This can be especially convenient in the case when the magnets are intended to interact with individual coils. Additionally or alternatively, ferromagnetic material can also be arranged in correspondence with the coils, such as between the coils (for example, between interconnected coils) and/or radially outside and/or inside the coils.

In some embodiments of the invention, the subsystem comprises at least one annular magnet or at least one annular coil arranged in a plane perpendicular to a longitudinal axis of the capturing element, wherein said annular magnet or annular coil is asymmetrically positioned in relation to the longitudinal axis. The reason for this is that it has been found that sometimes, at least in some embodiments, the oscillating movement of the capturing element may not be in one single vertical plane, but it can actually acquire a circular or curved component, especially if tuning magnets are present (such tuning magnets will be discussed below). If such a circular or curved component is present, having at least one coil displaced so that its centre point is substantially spaced from the longitudinal axis of the system and of the capturing element (here, reference is made to the longitudinal axis of the capturing element when the capturing element is at rest, that is, not oscillating), can enhance the energy production, as it enhances the relative movement between the asymmetrically placed coil and symmetrically placed rings of magnets, or vice-versa. For example, several asymmetrically placed coils can be arranged in several planes one above the other, and the displacement of their centre points in relation to the longitudinal axis can be in different radial directions from the longitudinal axis. For example, in one possible embodiment, three asymmetrically placed coils are placed in three different planes, one above the other, and their centre points are displaced from the longitudinal axis in three different directions angularly spaced by for example 120 degrees in relation to each other. When asymmetrically placed coils are used, the annular magnets can be placed symmetrically in relation to the longitudinal axis (that is, so that the longitudinal axis passes through the centres of the annular magnets), and vice-versa. This solution is applicable not only in the cases in which the plane (or planes) with a coil includes one or more individual coils, but also in for example cases in which one or more planes each include two coils connected in series as explained above.

In some embodiments of the invention, the magnets are arranged such that when the capturing element moves during the oscillatory movement from a neutral position to an extreme tilted position, said at least one coil is subjected to at least one change of polarity or direction of magnetic field, preferably to a plurality of changes of direction of the magnetic field.

In some embodiments of the invention, there are several subsets of magnets arranged in different planes at different heights above the base, for example, as several rings arranged one above the other, and with coils arranged in planes between the planes with the magnets.

In some embodiments of the invention, the generator comprises means for generating a magnetic field which produces a magnetic repulsion force between the capturing element and the subsystem support, a repulsive force that varies with the oscillating movement of the capturing element and which has a maximum value (that is, a maximum value which occurs once in each half cycle of the oscillating movement, when the capturing element—or, rather, the inner surface of the capturing element-reaches the position where it is closest to the subsystem support). When the amplitude of the oscillating movement of the capturing element increases, this position gets closer and closer to the subsystem support, and thus the maximum level of the repulsive force increases accordingly.

Therefore, the magnetic repulsion force between the capturing element and the subsystem support increases when the amplitude of the oscillating movement increases and decreases when the amplitude of the oscillating movement decreases. It has been observed that when the wind speed increases, the amplitude of the oscillating movement of the capturing element also increases and the maximum value of the repulsion force also increases. As wind speed continues to increase, although the amplitude grows at a declining rate, the repulsion force on the contrary increases very quickly—since this increase is preferably inversely proportional to the square of a distance between the relevant portions of the capturing element and the subsystem support —allowing the system to store potential energy in the magnets which is completely or substantially converted to kinetic energy (velocity) as the capturing element passes through the neutral position of zero bending. This provides for an increase in the natural oscillation frequency of the capturing element. In other words, the repulsion force modifies the behaviour of the capturing element as if the Young's modulus or elasticity modulus of the capturing element were variable. Therefore, when the wind speed increases, the natural oscillation frequency of the capturing element also increases automatically, and vice-versa. Thus, a passive adaptation or passive control of the resonance frequency of the capturing element as a function of wind speed is achieved, which can serve as an alternative or complement to active adaptation, such as the one based on the application of a voltage to a piezoelectric material described in WO-2014/135551-A1.

For example, in the case of a pole-shaped capturing element that does not have a system for adapting the resonance frequency, when the wind speed is too low the pole does not oscillate. As wind speed increases and approaches the speed at which the frequency of appearance of vortices coincides with the natural oscillation frequency of the structure, the amplitude of the oscillation of the pole increases, until reaching a maximum. If the wind speed continues to increase, the amplitude begins to decrease, since the vortices start to be generated too quickly, whilst the natural oscillation frequency of the structure remains constant. Finally, if the wind speed continues to increase even further, the pole stops oscillating. The narrow wind speed range from the speed at which the pole starts oscillating to the speed at which the pole stops oscillating is called the “lock-in” range. One effect of these embodiments of the invention is that, owing to the adaptation of the natural oscillation frequency of the system, a wider lock-in range can be obtained.

Although this kind of adaptation of the natural oscillation frequency of the system could also be achieved with a support element arranged outside the capturing element, for example, surrounding the capturing element completely or partially (such as described in WO-2016/055370-A2), arranging the support element within the capturing element involves certain advantages. For example, a very compact arrangement can be obtained, with outer dimensions substantially corresponding to the dimensions of the capturing element, especially in terms of the maximum radial extension of the generator. An efficient use of space is obtained, for example, use is made of the empty space within the capturing element. The dimensions of the capturing element are at least in part determined by the need to interact with the air and the need to synchronise the production of vortices along the capturing element. Thus, for a given desired height of the capturing element, the diameter of the capturing element will preferably be within a certain range (and generally vary in the axial direction of the capturing element, as described above). In prior art arrangements, such as those described in WO-2014/135551-A1, the space within the capturing element—the capturing element can often be chosen to be hollow to minimize the use of material and/or weight—is wasted.

Taking advantage of this space for incorporating a system for passive tuning of the natural frequency of oscillation of the capturing element is therefore an advantage, not only from a logistic point of view: it also makes it possible to produce this kind of generators with an attractive design, and without any need (or with a reduced need) for an external structure supporting magnets, for example, radially outside the capturing element or below the capturing element, radially spaced from for example a rod supporting the capturing element.

On the other hand, providing for the repulsion between the capturing element and the subsystem support within the capturing element makes it possible to provide for the repulsion at a substantial distance from the base, which can be advantageous for the purpose of making efficient use of magnetic material, taking advantage of the “lever effect”. That is, it provides for an efficient use of the magnetic material needed to produce the tuning of the natural frequency of oscillation of the capturing element to the wind speed. A given repulsion force provided by the magnets has a larger impact on the natural frequency of oscillation if it is applied at a position where the angular momentum of the capturing element is relatively small. Therefore, it is advantageous to provide the magnets in charge of producing this repulsion at a relatively large distance from the point where the capturing element is anchored, that is, at a relatively large distance from the base.

In some embodiments of the invention, the means for generating a magnetic field comprise at least one first magnet (for example, one or more annular magnets, or a plurality of magnets which are arranged at two or more points, preferably diametrically opposed, on the capturing element, for example, forming continuous or discontinuous rings at one or more heights within the capturing element) associated to (for example, attached to) the capturing element and at least one second magnet (for example, one or more annular magnets, or a plurality of magnets which are arranged in correspondence with two or more points, preferably diametrically opposed, of the subsystem support, for example, forming continuous or discontinuous rings, at one or more heights of the subsystem support) associated to (for example, attached to) the subsystem support. Said at least one first magnet and said at least one second magnet are arranged in such a way that they repel each other and in such a way that when the oscillating movement of the capturing element takes place, the distance between said at least one first magnet and said at least one second magnet varies in accordance with said oscillating movement. As the repulsion force between the two magnets is inversely proportional to the square of the distance between the magnets, the force will vary substantially during the oscillation of the capturing element and its maximum value may depend significantly on the amplitude of the oscillating movement. Thus, a variation in the amplitude of oscillation of the capturing element will correspond to a variation in the maximum repulsive force and, therefore, to a variation of the natural oscillation frequency of the capturing element.

In some embodiments of the invention, the at least one first magnet comprises at least two diametrically opposed parts and the at least one second magnet comprises at least two diametrically opposite parts, facing the at least two diametrically opposed parts of the at least one first magnet. In this way, when the swaying or oscillating movement of the capturing element takes place, the first and second magnets approach each other on one side of the support element while moving away from the diametrically opposite side, and an oscillating force is produced on the capturing element, the sign and amplitude of which vary periodically, depending on the distances between the magnets.

In some embodiments of the invention, the at least one first magnet is configured as at least one ring, for example, as several rings at different heights, and/or the at least one second magnet is configured as at least one ring, for example, as several rings at different heights. These rings can be formed of juxtaposed individual magnets. The use of magnets in the shape of a ring, for example, horizontal rings, may be useful for the generator to work in the same way regardless of wind direction. However, for example, in places where the wind blows (or other fluid flows) in only a limited range of directions, it may be enough to have pairs of first and second magnets arranged in the predictable vertical planes of oscillation of the capturing element.

In some embodiments of the invention, the at least one first magnet comprises a plurality of first magnets arranged at different heights above a base of the generator and the at least one second magnet comprises a plurality of second magnets arranged at different heights above a base of the generator.

By choosing the size and strength of the magnets, the number of magnets and the number of rows of magnets in the vertical direction, as well as the position of the magnets, an interaction between the magnets associated to the capturing element and the magnets associated to the subsystem support can be set, which serves for the natural frequency of the capturing element to vary in the most aligned manner possible with the frequency of appearance of the vortices, which in turn varies according to the relative velocity between the fluid (for example, air) and the capturing element.

In some embodiments, the at least one first magnet comprises a first plurality of magnets arranged substantially adjacent to each other, for example, above each other or side by side in the horizontal plane, and with polarities arranged (for example, in accordance with the Halbach array) so that the magnetic field produced by the first plurality of magnets is stronger on a side of said magnets facing the at least one second magnet than on an opposite side, and/or the at least one second magnet comprises a second plurality of magnets arranged substantially adjacent to each other, for example, above each other or side by side, and with polarities arranged (for example, in accordance with the Halbach array) so that the magnetic field produced by the second plurality of magnets is stronger on a side facing the at least one first magnet than on an opposite side. This arrangement serves to enhance the efficiency of the magnets in terms of their contribution to the increase of the resonance frequency of the capturing element when the speed of the fluid increases, and vice-versa. That is, basically, when arranging the magnets in this manner, for example, following the Halbach array layout, that is, arranging the magnets in this way known to augment the magnetic field on one side of the array while cancelling the field to near zero on the other side, the magnetic field will be strongest on the side where the first and second magnets face each other, and thereby provide for an efficient use of the magnets.

In some embodiments, the at least one first magnet and the at least one second magnet are arranged in an inclined manner in relation to a longitudinal axis, such as a vertical axis, of the capturing element. In some embodiments, the inclination is such that the distance between the magnets and an axis of symmetry or a longitudinal axis of the capturing element increases as a function of the height above a bottom end of the capturing element or the base. For example, the first and second magnets can be arranged as rings of magnets having a truncated cone shape or at least one surface shaped as a truncated cone. This inclination has been found to be useful to introduce a torque that can serve to reduce or eliminate a tendency of the capturing element to enter resonant modes different from the one corresponding to its natural frequency of oscillation.

In some embodiments, the second end is at a distance H above the first end, and the means for generating a magnetic field are placed at a distance of more than 0.05H from (such as above) the first end, preferably at a distance of more than 0.1H from the first end, even more preferably at a distance of more than 0.2H, such as at a distance of more than 0.3H or more than 0.4H from the first end, and optionally at a distance of at least 0.1 H from (such as below) the second end, such as at a distance of more than 0.2H, more than 0.3H or more than 0.4H from the second end.

Placing the means for generating the repulsive magnetic field at a substantial height above the base can be advantageous in that it may help to reduce the amount of magnetic material, such as neodymium alloy, needed to achieve the necessary adaptation or tuning of the natural frequency of oscillation. This is believed to be due, at least in part, to the lever effect. As explained above, a given repulsion force will have a larger impact on the natural frequency of oscillation if it is applied at a point where the angular momentum is small. The angular momentum of a pole oscillating in a swaying manner in relation to a base to which one end of the pole is anchored decreases with the distance to the base, that is, it is smaller far away from the base than close to the base.

Some embodiments combine the above teachings. For example, one or more magnets forming part of the means for generating a magnetic field which produces a magnetic repulsion force between the capturing element and the support element may also form part of the subsystem for converting the oscillating movement of the capturing element into electrical energy. Thereby, efficient use is made of the magnetic material, which serves to further reduce the cost of the generator.

Another aspect of the invention relates to a method for making an electrical power generator tune with wind speed. The method comprises the step of placing at least one first magnet on the capturing element and at least one second magnet on the subsystem support, such that the at least one first magnet and the at least one second magnet repel each other. The effect achieved with this arrangement has been explained above. It helps to automatically adapt the natural oscillation frequency of the capturing element to the frequency of appearance of vortices.

Another aspect of the invention relates to the use of a plurality of magnets in an electrical power generator comprising a capturing element as described above. The fluid may have a substantially stationary and laminar flow, which is often the case with the wind. The capturing element is configured such that, when the fluid moves, the capturing element generates vortices in the fluid in such a way that a lift force is generated on the capturing element which produces an oscillating movement of the capturing element, as described in, for example, EP-2602483-A1 or WO-2014/135551-A1. The generator also comprises a support extending at least partially within the capturing element, for example, in parallel with a longitudinal axis of the capturing element, until a certain height. The use of the magnets is intended to generate an automatic adaptation of the natural oscillation frequency of the capturing element to the wind speed.

Another aspect of the invention relates to a method for making an electrical power generator as the one previously described tune with wind speed. The method comprises the step of placing at least one first magnet on the capturing element and at least one second magnet on a support extending at least partially within the capturing element, such that the at least one first magnet and the at least one second magnet repel each other. The effect achieved with this arrangement has been explained above. It helps to automatically adapt the natural oscillation frequency of the capturing element to the frequency of appearance of vortices.

Another aspect of the invention relates to the use of a plurality of magnets in an electrical power generator comprising a capturing element as described above, for example, in the shape of a post, pillar or pole, configured to be located in a fluid, for example, in the air, although there are also other possibilities, such as water. The fluid may have a substantially stationary and laminar flow, which is often the case with the wind. The capturing element is configured such that, when the fluid moves, the capturing element generates vortices in the fluid in such a way that a lift force is generated on the capturing element which produces an oscillating movement of the capturing element, as described in, for example, EP-2602483-A1 or WO-2014/135551-A1. The generator also comprises a support extending at least partially within the capturing element, for example, in parallel with a longitudinal axis of the capturing element, until a certain height. The use of the magnets is intended to generate an automatic adaptation of the natural oscillation frequency of the capturing element to the wind speed.

Another aspect of the invention relates to an electrical power generator comprising:

a capturing element having an elongated shape, the capturing element extending in a longitudinal direction between a first end of the capturing element and a second end of the capturing element, the capturing element being configured to be attached to a base and submerged in a fluid with the first end closer to the base than the second end, the capturing element being configured such that, when the fluid moves, the capturing element generates vortices in the fluid so that an oscillating lift force is generated on the capturing element, which produces an oscillating movement of the capturing element; and

a subsystem for converting the oscillating movement of the capturing element into electrical energy. The subsystem is placed at least partly within the capturing element (for example, for the reasons explained above), and comprises a plurality of coils comprising at least three coils arranged side by side in a plane perpendicular to a longitudinal axis of the capturing element and preferably substantially symmetrically in relation to said longitudinal axis. That is, instead of using more or less coaxially arranged coils as in some embodiments described herein, here the different coils are placed side by side. The expression “side by side” is intended to specify that the coils are not arranged concentrically around a common axis in a coaxial manner, as in some embodiments described above, but separately although more or less close to each other. The coils preferably have their axes aligned in parallel. The space between the coils, if any, is preferably relatively small so as to make efficient us of the space within the capturing element and so as to optimize the production of energy. The coils can for example be arranged in a circle, that is, so that the coils are placed at different angular positions in relation to the longitudinal axis of the capturing element when it is in its neutral position.

The subsystem further comprises at least one pair of magnets arranged to produce a magnetic field. The coils and the magnets are arranged so that the oscillating movement of the capturing element produces a relative movement between the at least one pair of magnets and the coils so as to generate an electromotive force in the coils.

This arrangement has been found to allow for a relatively light-weight subsystem for energy conversion, making efficient use of magnetic material and coils. Especially, the arrangement makes it possible to embody the capturing element, including the components attached to it, so that its weight is relatively low, which enhances its capacity of oscillating with a large amplitude under the effect of the vortices, and also serves to increase the lock-in range. The arrangement has been proven to work efficiently with a relatively small amount of magnetic material attached to the capturing element. For example, efficient energy conversion is achieved also when the oscillating movement of the capturing element is not limited to one single vertical plane, and without any need for using rings of magnets attached to the capturing element, which helps to reduce the weight of the capturing element.

The use of a plurality of coils arranged in the same plane around the axis of symmetry, that is, in a circle or similar in the horizontal plane when the capturing element extends in the vertical direction, has been found to be appropriate for efficient energy conversion taking into account that the oscillation may not be strictly limited to one single vertical plane, but can involve a circular or curved component, as explained above. The pair of magnets can thus be arranged to interact with the coils efficiently during this circular movement, and without any need for using rings of magnets.

In some embodiments, the pair or pairs magnets are attached to the capturing element so as to oscillate with the capturing element, whereas the coils are attached to a subsystem support structure, for example, to a subsystem support structure that supports part of the subsystem and that extends into the capturing element. The subsystem support structure can be fixed in relation to the base whereas the capturing element can be arranged so that it oscillates in relation to the base, such as in relation to a point where it is anchored to the base.

In some embodiments, the generator further comprises additional magnets arranged in such a way that the additional magnets and the at least one pair of magnets repel each other and in such a way that when the oscillating movement of the capturing element takes place, the distance between the additional magnets and the at least one pair of magnets varies according to the oscillating movement. This serves to tune the natural frequency of oscillation, as explained above.

In some embodiments, the plurality of coils consists of three coils situated around the longitudinal axis and having their axial centre portions angularly spaced by approximately 120 degrees from the axial centre portions of the adjacent coils. That is, three coils are spaced symmetrically around the longitudinal axis.

The capturing element can be as described above or different, that is, it may or may not have a shape as described above. For example, in some embodiments of this last aspect of the invention, the capturing element may have a characteristic dimension that actually increases throughout most of the length of the capturing element from the first end to the second end, as known in the art. The subsystem may be partly arranged on a subsystem support in accordance with the principles described above.

In some embodiments of the invention, the longitudinal axis of the capturing element is arranged to extend generally vertically when the capturing element is not oscillating.

In some of these embodiments of the invention, some or all the magnets that are part of the subsystem for converting the oscillating movement of the capturing element into electrical energy by inducing electrical current in the coils can also serve for at least part of the tuning of the natural oscillation frequency of the capturing element to wind speed. For example, at least some of the first magnets can be part of the subsystem used to induce current in the coils, which is why these magnets may have a dual function, thereby making efficient use of magnetic material.

A generator according to the invention can, for example, be used to provide energy both in rural and in urban areas, for example, instead of or as a complement to solar power. For example, where a solar power installation exists, one or more generators according to the invention can be installed as a complement, for example, so that power can be produced also when there is not enough sunlight, for example, at night or during so-called bad weather. Here, use can be made of the circuitry already installed for adapting and conducting the electrical power obtained by the solar cells: this circuitry can be used and/or adapted to also conduct the energy coming from the generators according to the invention. As these generators can be provided with a slim and attractive design, and with many of their components within the slim and elegant pole used for capturing the energy from the wind, installing this kind of generators on buildings or other places may appeal to people.

In spite of the automatic tuning used in some of the embodiments described above, sometimes and maybe especially in the case of rapid changes in wind speed, the automatic tuning provided by the magnets may not be enough. Another way of tuning, or a complementary tuning, can be based on controlled injection or extraction of energy into/out of the subsystem(s) for converting movement into electrical energy.

A further aspect relates to a method of producing electrical power with an electrical power generator as described above, comprising the step of subjecting the capturing element to a moving fluid (such as moving air, that is, wind) so that the capturing element is caused to oscillate due to von Karman vortices induced in the fluid by the capturing element. The von Karman vortices are preferably generated in a substantially synchronized manner along the capturing element. This can be achieved or optimized by selecting the shape of the capturing element as described above.

### BRIEF DESCRIPTION OF THE DRAWINGS

To complement the description and with the object of helping to a better understanding of the features of the invention, in accordance with examples of practical embodiments of the same, a set of drawings is attached as an integral part of the description, which by way of illustration and without limitation represent the following:

FIGS. 1A and 1B are a schematic elevational view and a cross sectional view, respectively, of an electrical power generator according to an embodiment of the invention.

FIG. 2 shows the effect of a laminar airflow passing across a capturing element of the electrical power generator according to this embodiment of the invention.

FIG. 3 shows the effect of the oscillation of the capturing element of the electrical power generator according to this embodiment of the invention.

FIGS. 4A and 4B schematically illustrate the effect on the wind in correspondence with a top portion of an electrical power generator as known in the prior art and of an electrical power generator according to an embodiment of the invention, respectively.

FIGS. 5A and 5B show a schematic distribution of the centres of the vortices in an electrical power generator as known in the art and according to an embodiment of the invention, respectively.

FIGS. 6A, 6B and 6C are schematic elevational and cross sectional views of the capturing element according to three different embodiments of an electrical power generator according to the invention.

FIGS. 7A and 7B show the top views of capturing elements of two different embodiments of electrical power generators according to the invention.

FIGS. 8A-8E are schematic cross sectional views (FIGS. 8A and 8E) and schematic top views (FIGS. 8B-8D), respectively, of a portion of a subsystem for converting oscillating movement into electrical power in accordance with different embodiments of the invention.

FIGS. 9A and 9B illustrate two simplified models of the behaviour of the capturing element without any tuning system (FIG. 9A) and with a tuning system (FIG. 9B), respectively.

FIG. 10 represents the evolution against displacement (x) of the spring force (Fₖ) and of the magnetic repulsion force (F_{b}).

FIG. 11 represents the variation over time of the amplitude (displacement x) and frequency (oscillation along the time axis t) of a device without tuning (I) and a tuned device (II) (movement with magnetic repulsion) when subjected to the action of an instantaneous force in the initial instant.

FIGS. 12A-12E are views analogous to the ones of FIGS. 8A-8E, but of an alternative arrangement of coil and magnets.

FIGS. 13A and 13B schematically illustrate the oscillatory movement of the capturing element in two different embodiments or modes of operation of the invention.

FIG. 13C schematically illustrates the arrangement of the coil in relation to the longitudinal axis of the generator in accordance with an alternative embodiment of the invention.

FIGS. 14A and 14B are a schematic elevational view and a cross sectional view, respectively, of a portion of another embodiment of the invention.

### DESCRIPTION OF EMBODIMENTS OF THE INVENTION

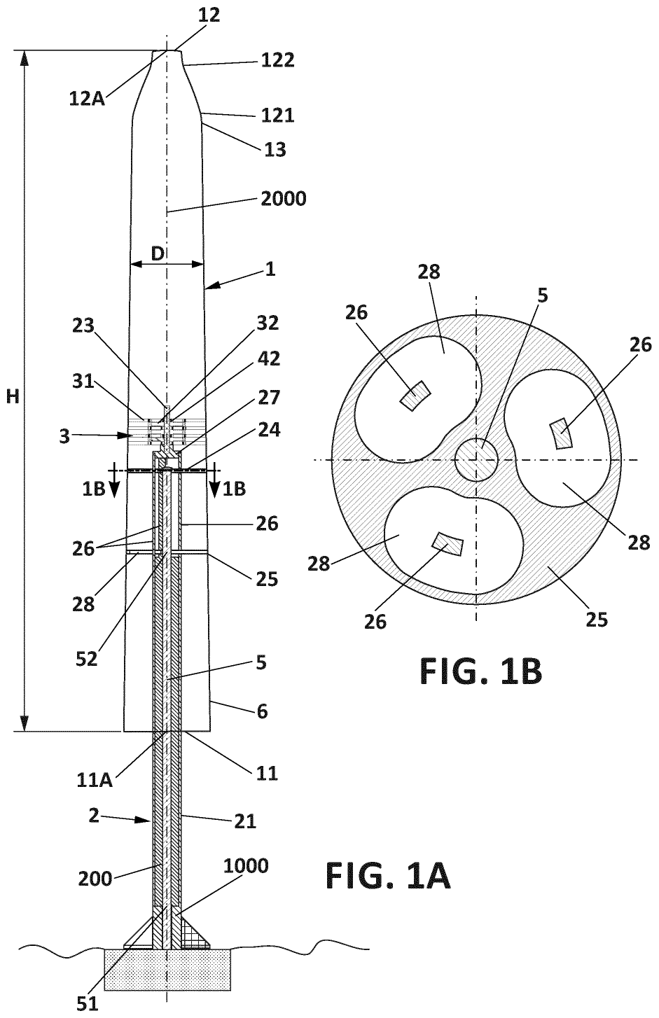

FIG. 1A shows, schematically, an electrical power generator according to one possible embodiment of the invention. The generator comprises a capturing element 1 in the shape of vertically arranged pole (that is, a pole having a longitudinal axis 2000 arranged vertically) with a first end 11 (the bottom end of the capturing element 1 when arranged as shown in FIG. 1) and a second end 12 (the top end of the capturing element 1 when arranged as shown in FIG. 1). The height or length H of the capturing element 1 is the distance between its first end 11 and its second end 12. In this embodiment, the capturing element 1 has a circular cross section, which is often advantageous in that it allows the generator to operate in the same way independently of the direction of the wind.

The generator further comprises a subsystem support 2 for supporting part of a subsystem for converting the oscillating movement of the capturing element 1 into electrical power, which will be described below. In this embodiment, the subsystem support 2 comprises a generally cylindrical housing 21 extending coaxially with the longitudinal axis 2000 of the capturing element 1 (when the capturing element is in its neutral position). The generator further comprises a support element that supports the capturing element, in this case, a support element in the form of a rod member 5 arranged within generally cylindrical housing 21 of the subsystem support 2. The rod member 5 is anchored to the base 1000, corresponding to a first attaching point 51. Also the subsystem support 2 is attached to the base 1000. From there, the subsystem support 2 comprises a first section extending upwards surrounding the rod member 5, defining a space 200 between the rod member 5 and the cylindrical housing 21 within which the rod member 5 can oscillate laterally. Towards the top, the generally cylindrical housing 21 of the subsystem support 2 terminates in three separate axially extending legs or sections 26 that extend axially further into the capturing element 1. There, the support element 2 terminates in a platform 27 provided with an axially projecting member 23 arranged for supporting part of a subsystem 3 for converting the oscillating movement of the capturing element 1 into electrical power. This subsystem 3 comprises a first subsystem component 31 with magnets arranged so that during the oscillatory movement the magnets are displaced in relation to a second subsystem component 32 comprising one or more coils. The first subsystem component is attached to the capturing element 1, and the second subsystem component 32 is supported by the subsystem support 2, on the platform 27. In this embodiment, additional magnets 42 are provided for the purpose of tuning the natural frequency of oscillation of the capturing element 1, as explained above. Also these magnets 42 are placed on the axially projecting member 23. It may be preferred to use a material of low magnetic permeability for the axially projecting member 23 to prevent, at least to a certain extent, the magnetic field of the magnets 42 to be directed through this projecting member 23, which could result in a loss of efficiency of the magnets in terms of their contribution to the tuning of the natural frequency of oscillation of the capturing element 1.

The rod member 5 is elastic. The term “elastic” does not exclude the possibility of using a relatively rigid rod member 5, but merely implies that the rod member should have enough capability of bending/inclining sideways to allow for causing an oscillating movement of the capturing element 1 in relation to the base 1000, that is, an oscillating movement according to which the capturing element 1 is inclined first to one side and then to the other, etc.

The capturing element 1 is attached to the rod member 5 by means of two substantially disc-shaped members 24, 25, which are arranged to attach the capturing element 1 to the rod member 5 as schematically shown in FIGS. 1A and 1B. The disc-shaped members 24, 25 are fixed to the rod member 5, which passes through a centre opening present in the disc-shaped members 24, 25. Each disc-shaped member 24, 25 further comprises three larger openings 28 radially spaced from the centre of the disc-shaped member. As shown in FIGS. 1A and 1B, the legs or axial extensions 26 of the subsystem support 2 extend through these openings 28, which are large enough to allow the disc-shaped member to oscillate with the rod 5 without interfering with the legs 26. In this way, the subsystem support 2 ends above the upper axial end of the rod member 5, so that the equipment or subsystem 3 for converting the oscillatory movement of the capturing element into electrical power and also the equipment for tuning the natural frequency of oscillation can be placed above the rod member 5, without any risk of interfering with it during oscillation.

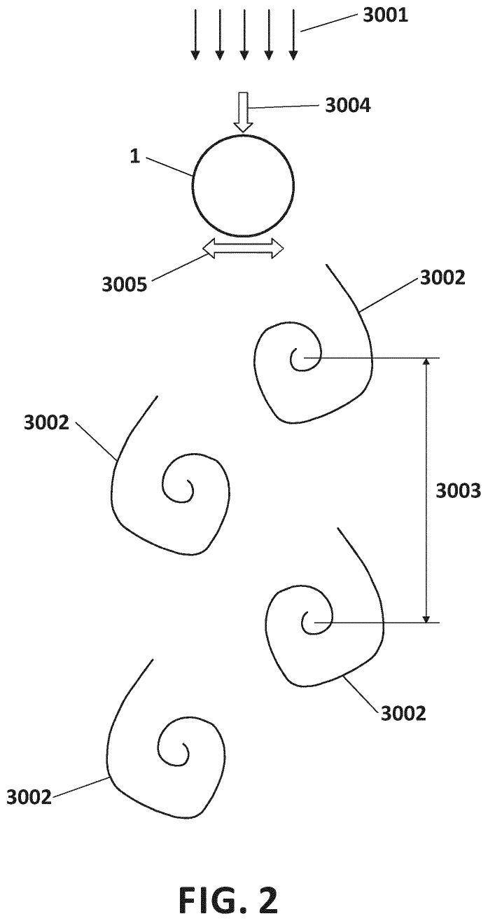

As shown in FIG. 2, when the laminar flow 3001 of the wind impacts against the elongated pole-shaped capturing element 1, it produces a series of vortices 3002 that occur alternately on one side and on the other side of the capturing element 1 and with a constant distance 3003 between the successive vortices on each side of the capturing element 1. Therefore, a substantially constant drag force 3004 in the direction of the wind and a lift force 3005 substantially perpendicular to the general direction of the wind and to the direction of the drag force are produced on the capturing element 1. This lift force 3005 switches sign periodically, with a frequency that corresponds to the onset of the vortices, and this force causes the oscillation of the capturing element 1, towards one side and towards the other side. In this embodiment of the invention, the capturing element 1 has a circular cross section.

The capturing element 1 shown in FIG. 1 features a cross section with a diameter D that decreases with height from the first end 11 (corresponding to a first longitudinal position 11A) to the second end 12 (corresponding to a second longitudinal position 12A), for the reasons explained above. The decrease rate is substantially constant during most of the distance from the first end 11 to the second end 12, more specifically, between the first end 11 and a position referred to herein as the cover point 13, where the decrease rate increases. Thus, between the first end 11 and the cover point 13, in this embodiment the outer side of the cross section of the capturing element is substantially straight or, if curved, features a very large curvature radius.

As schematically illustrated in FIG. 1A, the subsystem 3 is placed under the axial centre portion of the capturing element 1 but still relatively close to it. There, the diameter is relatively large and the amplitude of the oscillation is not so big so as to cause physical interference between the moving parts associated to the capturing element and the parts placed on the subsystem support. Thus, a balance exists between the need for space to accommodate the subsystem, the desire the place the subsystem and the tuning magnets at a substantial distance from the base so as to take advantage of the “lever effect”, and the desire for a substantial amplitude of oscillation to enhance energy production.

As explained above, it has been found that an abrupt termination of the capturing element at the top end thereof may generate additional vortices that disturb the vortices that cause the oscillatory movement. It has been found that it is advantageous to provide a top portion of the capturing element where the diameter decreases towards the second end in a way that reduces or minimizes this disturbance. More specifically, as from the cover point 13, the capturing element features a first portion 121 where the diameter is decreasing in the direction from the first end 11 to the second end 12 at a higher rate than before the cover point, that is, from the cover point the decrease rate increases in the direction from the first end 11 to the second end 12 in correspondence with this first portion 121 of the capturing element. This first portion 121 is followed by a second portion 122, which is in turn a portion where the diameter is also decreasing in the direction from the first end 11 to the second end 12, but with the decrease rate decreasing in the direction from the first end 11 to the second end 12. Thus, and differently from many prior art arrangements discussed above, the diameter does not decrease with a constant or increasing decrease rate all throughout the axial extension from the cover point to the second end, but features at least one point where the decrease rate decreases. This has been found to improve the efficiency of the generator in terms of its capacity of capturing energy from the wind.

In some embodiments, the capturing element 1 does not have a circular cross section, but a cross section with a different shape, for instance, the shape of a polygon with rounded edges. Accordingly, the relations and formulae discussed herein are still valid for these embodiments, but replacing the word “diameter” by the expression “characteristic dimension”, which is the diameter of a circle with the same surface area as the cross section of these embodiments.

In the embodiment shown in FIG. 1, the capturing element 1 further comprises a skirt 6, which is a hollow part of the capturing element 1 which surrounds the subsystem support 2 and the rod member 5 below the position where the capturing element is fixed to the rod member 5. This skirt 6 is thus the piece of the capturing element 1 comprised between the second attaching point 52 of the rod member 5 (that is, in this embodiment, the point where the lowest disc-shaped element 25 attaches the capturing element 1 to the rod member 5) and the first end 11 of the capturing element 1. In this embodiment, the distance between the second attaching point 52 of the rod member 5 and the first end 11 of the capturing element 1 is substantially equal to the distance between the first end 11 of the capturing element 1 and the first attaching point 51 of the rod member 5. In some embodiments, a cover member (not shown in FIG. 1) having, for example, a substantially cylindrical shape can be arranged surrounding the subsystem support 2 between the skirt 6 and the surface on which the generator is mounted, for example, to improve the appearance of the generator. In other embodiments, the skirt 6 can extend further towards the base so as to conceal the subsystem support 2.

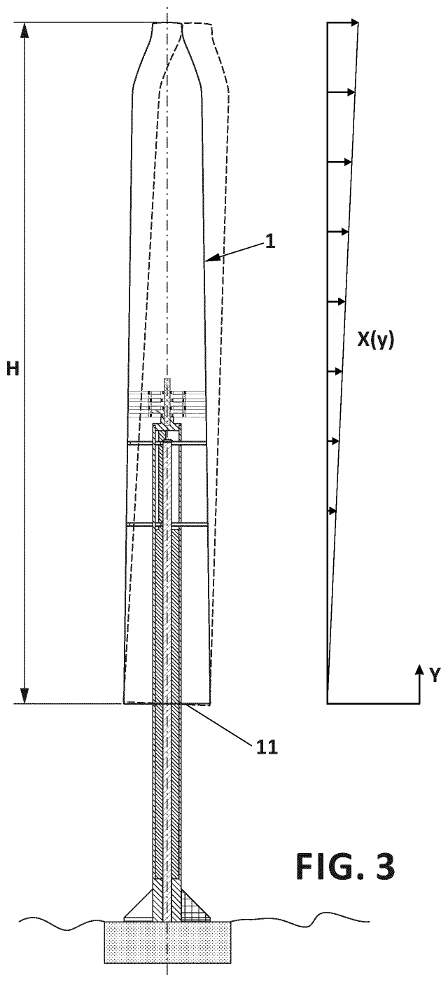

FIG. 3 shows the capturing element of the embodiment of FIGS. 1A and 1B in two different positions, an equilibrium position and a maximum amplitude position. X(y) represents the amplitude of this oscillatory movement with respect to the y coordinate, which is measured from the first end 11 of the capturing element 1.

The known formula for the calculation of the frequency of the appearance of new vortices may be used in a point where the oscillation of the capturing element is almost zero. In some particular embodiments, the first end of the capturing element is made coincident indeed with this point, as taught by WO-2016/055370-A2, to maximize energy capture efficiency. Thus, the following formulae are based on the presumption that the first end of the capturing element is a point where oscillation is almost zero.

At the first end 11 of the capturing element 1, the characteristic dimension is referred to as d, and estimated wind speed is referred to as v₁. As a consequence, at this wind speed, the frequency of appearance of new vortices in correspondence with the first end 11 will be

$$f = \frac{St \cdot {v}_{1}}{d}$$

If this frequency is calculated at a generic point of the capturing element, and if it is imposed as a design criterion that this frequency is to be equal along the whole capturing element, this would lead to the following expression

$$\frac{St \cdot {v}_{1}}{d} = \frac{St \cdot v ( y )}{φ ( y )}$$

wherein v(y) is the wind speed at a generic point located to a distance y from the first end, and ϕ(y) is the equivalent characteristic dimension of the capturing element at this point.

Without being bound by theory, this equivalent characteristic dimension may be expressed as a function of the characteristic dimension D(y) of the capturing element at this point when it does not move, and a contribution due to oscillation, in the following way:

ϕ(y)=D(y)+2·k₀·X(y)

wherein k₀ is an experimental constant which relates the influence of the amplitude of the movement X(y) on the value of the equivalent characteristic dimension ϕ(y).

However, as the amplitude of the movement may be expressed as a linear function of the coordinate y, the equivalent characteristic dimension ϕ(y) may be expressed in the following way:

$$φ ( y ) = D ( y ) + {k}_{1} \cdot \frac{y}{H} \cdot d$$

wherein k₁ is constant for each generator, and depends on the linear relation between the amplitude of the oscillation X(y) and the coordinate y.

If we introduce the expression of ϕ(y) into the first equation, the shape of the characteristic dimension of the capturing element will be given by the following non-dimensional expression:

$$\frac{D ( y )}{d} = \frac{v ( y )}{{v}_{1}} - {k}_{1} \cdot \frac{y}{H}$$

This expression shows two terms with opposed signs. Depending on the expression used for the estimation of v(y), D(y) will grow or decrease along the length of the capturing element. However, for standard values, it may be shown that there is a first longitudinal position closer to the first end than to the second end where the characteristic dimension is greater than at a second longitudinal position located closer to the second end than the first longitudinal position.

For example, if we use the Hellmann's exponential law for wind speed

$$\frac{v ( y )}{{v}_{1}} = \frac{v ( y )}{{v}_{1}} \cdot \frac{{v}_{10}}{{v}_{10}} = \frac{v ( y )}{{v}_{10}} \cdot \frac{{v}_{10}}{{v}_{1}} = {( \frac{y + {y}_{0}}{10} )}^{α} \cdot {( \frac{10}{0 + {y}_{0}} )}^{α} = {( \frac{y}{{y}_{0}} + 1 )}^{α}$$

where y₀ is the distance between the first end of the capturing element and the first attaching point of the support element.

Accordingly, the following expression of the characteristic dimension is obtained:

$$\frac{D ( y )}{d} = {( \frac{y}{{y}_{0}} + 1 )}^{α} - {k}_{1} \cdot \frac{y}{H}$$

If usual values, such as α=0.15, y₀=0.35 metres. H=1 metre and k₁=0.45 are used, the expression of

$$\frac{D ( y )}{d}$$

decreases with y from y=0 to y=H, so the first longitudinal position coincides with the first end and the second longitudinal position coincides with the second end, as shown in previous figures.

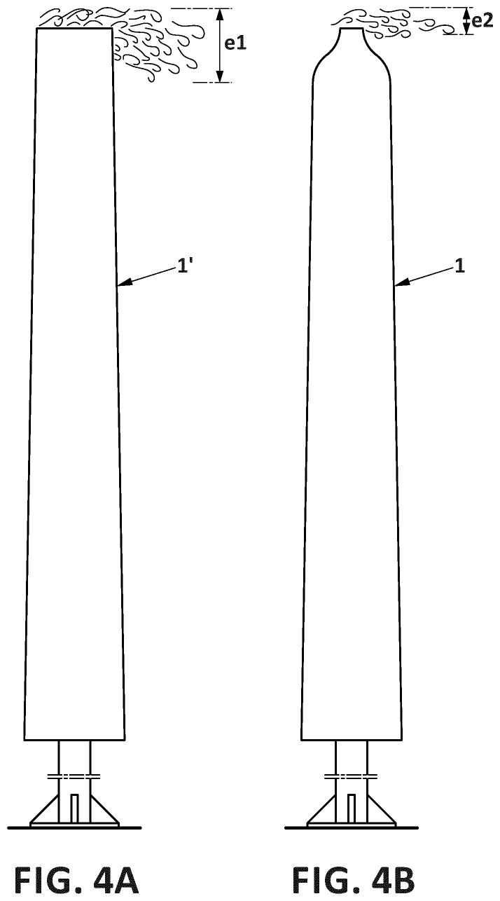

FIGS. 4A and 4B show a schematic comparison between the generation of vortices in correspondence with the upper end of a prior art capturing element 1′ (FIG. 4A) and the generation of vortices in correspondence with the upper end of a capturing element 1 in accordance with an embodiment of the invention (FIG. 4B).

More specifically, FIG. 4A schematically illustrates the effect of wind blowing against a capturing element as known in the art. A representation of the density of these upper vortices and the axial extension e1 of the capturing element 1′ affected by these upper vortices is shown in this figure.

FIG. 4B schematically illustrates the effect of wind blowing against a capturing element of an electrical power generator according to an embodiment of the invention. A representation of the density of these upper vortices and the axial extension e2 of the capturing element 1 affected by these upper vortices is shown in this figure. It can be observed how less upper vortices are formed and how the axial extension e2 of the capturing element 1 affected by them (FIG. 3B) is much smaller than the axial extension e1 affected by such vortices in the case of the prior art capturing element 1′ (FIG. 3A), due to the design of the upper zone of the capturing element 1.

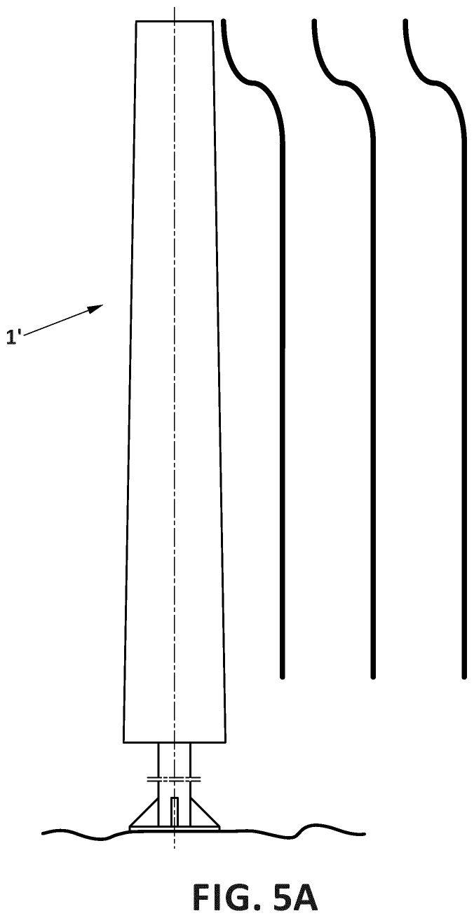

FIGS. 5A and 5B show the capturing elements of FIGS. 4A and 4B but instead of illustrating density of the upper vortices and their region of influence, a schematic distribution of the centres of the vortices along the capturing element is shown. Since vortices extend along the whole length of the capturing element, the line joining the centres of said vortices may be represented as a continuous line. As it may be seen in these figures, this line is not a straight line.

FIG. 5A shows a schematic distribution of the centres of the vortices in an electrical power generator with a capturing element as known in the art, which is severely affected by the upper vortices generated in the upper zone of the capturing element 1′, the density of which is shown in FIG. 4A. These upper vortices affect the normal operation of the generator, causing a delay in the aerodynamic scenario in the upper zone. The result is that the centres of the vortices in this upper zone are also delayed with respect to the rest of the centres of the vortices. This delay causes that the energy which is absorbed by the electrical power generator is lower, and this reduction in the absorption of energy takes place in the zone where in theory, the available energy is at its maximum. As a consequence, the performance of this electrical power generator is sub-optimal.

FIG. 5B, on the contrary, shows a schematic illustration of the centres of the vortices in an electrical power generator according to the embodiment of the invention shown in FIG. 4B, which is much less affected by the upper vortices than the generator of FIG. 5A, since, as shown in FIG. 4B compared with FIG. 4A, the density and extension of these upper vortices is much lower in the case of the capturing element of FIG. 4B. The result is that the aforementioned delay of the centres of the vortices affects a much smaller length of the capturing element, and therefore the distribution of the centres of the vortices is more similar to a straight line than in the previous case, and consequently more energy may be absorbed by the capturing element 1 in this zone. This makes the performance of this generator be better than the performance of the generator with the capturing element shown in FIG. 5A.

As explained above, this is achieved by terminating the capturing element in a way that differs from the “flat-cut” or “flat-dome-shaped” termination known in the art, that is, a termination similar to the one of a base-ball bat. Instead, the present invention involves at least one change from a higher to a lower decrease rate, for example, as in the illustrated embodiment, by transition from a convex portion 121 (where the longitudinal cross section of the capturing element is convex towards the exterior) to a concave portion 122 (see FIG. 1A).

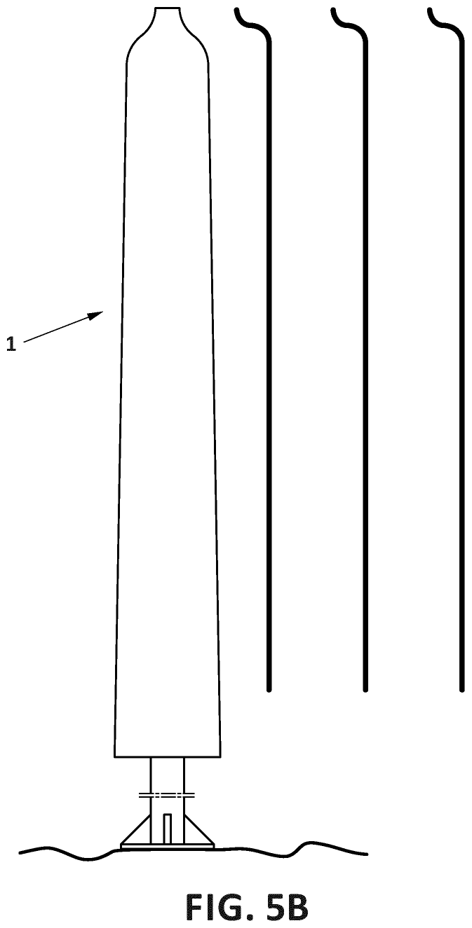

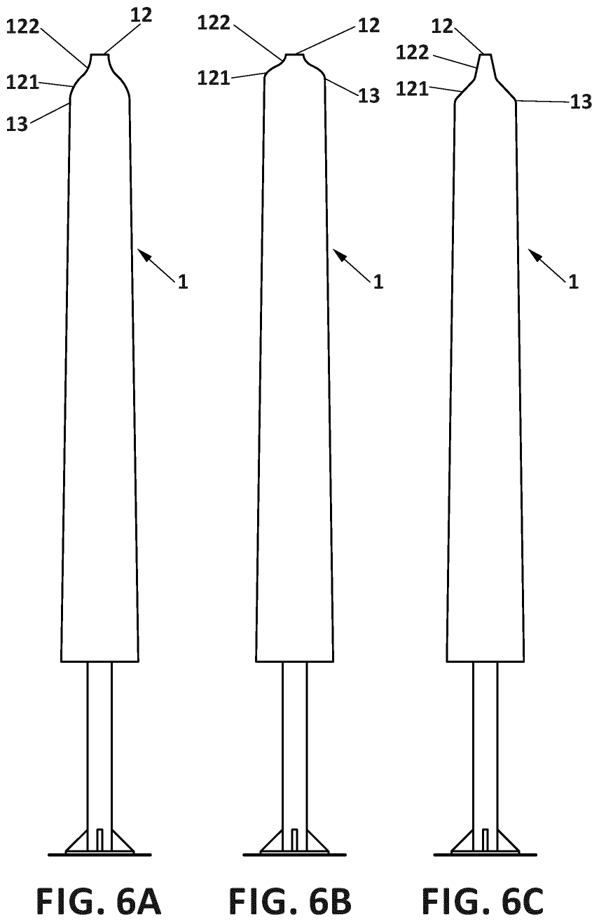

FIGS. 6A, 6B and 6C show three different embodiments of electrical power generators according to the invention with their upper ends designed to enhance performance based on the principles discussed above. In the first two embodiments, shown in FIGS. 6A and 6B, the first portion 121 is convex and the second portion 122 is concave, as seen from the exterior of the capturing element 1. However, in FIG. 6B, the distance between the cover point 13 and the second end is smaller than in the case of FIG. 6A. FIG. 6C shows a capturing element where the first portion 121 corresponds to a frustoconical section and the second portion 122 corresponds to another frustoconical section, but with a decrease rate (which in this case it is the apex angle) lower than the one of the frustoconical section of the first portion 121.

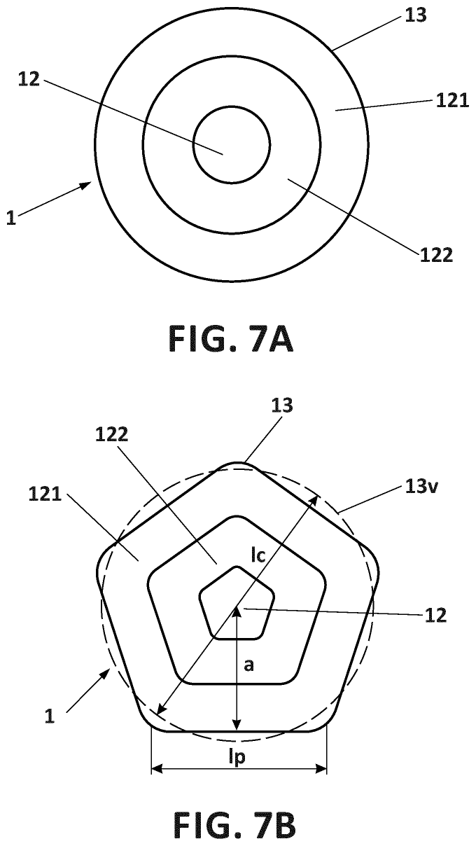

FIGS. 7A and 7B show the top views of capturing elements 1 of two different embodiments of electrical power generators according to the invention. These top views may be combined with all the previously illustrated embodiments, such as with the three different capturing elements shown in FIGS. 6A to 6C.

FIG. 7A shows a capturing element with a circular cross section.

FIG. 7B shows a capturing element with cross section that has the shape of a regular pentagon with rounded vertices. As this cross section is not circular, a graphic representation of the characteristic dimension Ic is also shown. A virtual circumference 13v of a circle which has the same area as the cross section of the capturing element 1 is represented in this figure, the area of this cross section depending on its side Lp and apothem a. The diameter of this virtual circumference is deemed to be the characteristic dimension Ic of the cross section of the capturing element 1.

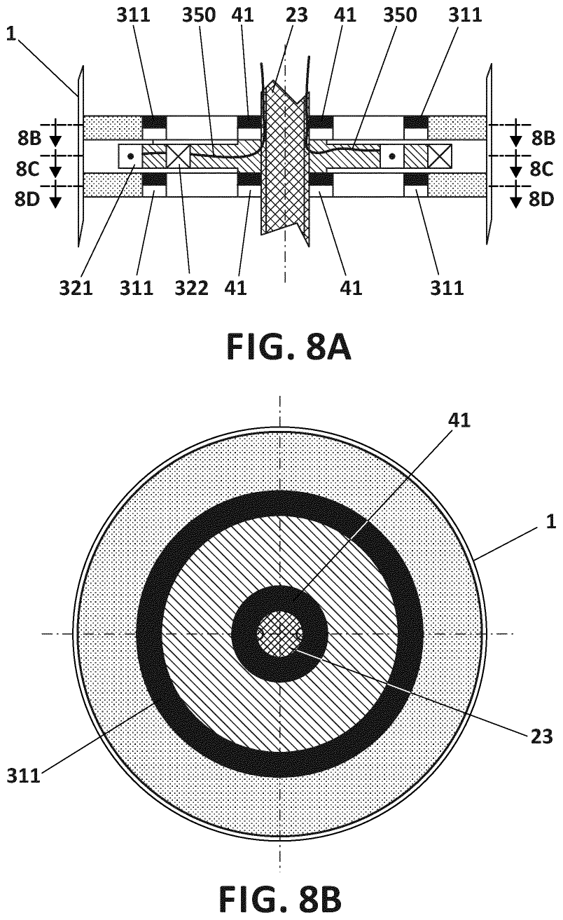

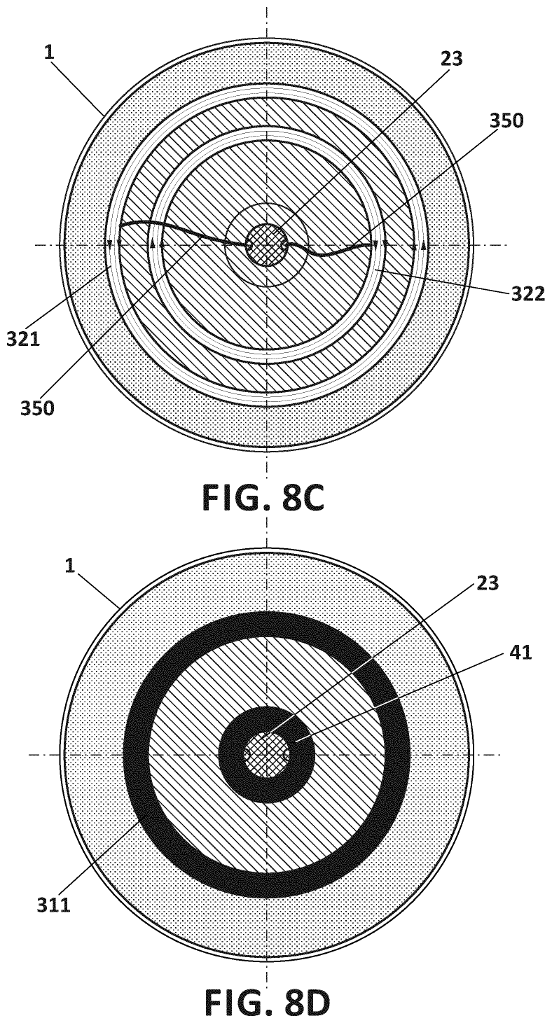

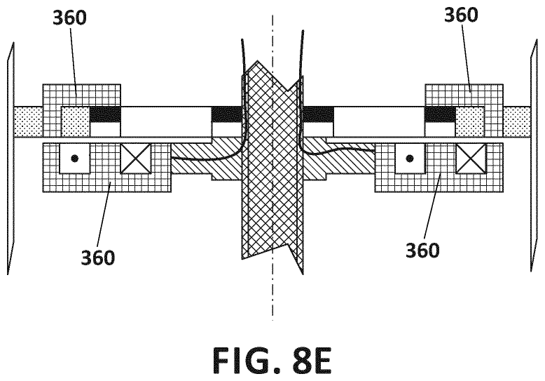

FIG. 8A schematically illustrates a portion of a subsystem for converting the movement of the capturing element 1 into electrical power. The subsystem comprises two coils 321 and 322 interconnected so that when current flows in one direction (such as clockwise) in one of the coils, it flows in the opposite direction in the other coil. The coils are attached to the subsystem support 2 and, more specifically, to a projecting member 23. Electrical conducting wires 350 are arranged for conducting the generated current away from the coils.

On the other hand, annular magnets 311 (for example, each formed by a plurality of individual magnets arranged one after the other in a ring) are provided above and below the coils. In this case, both annular magnets 311 have their N pole (black) directed upwards and their S pole (white) directed downwards. A magnetic field is established between the upper and the lower annular magnet, and when the capturing element oscillates, the magnets will move in relation to the fixed coils, so that the coils will be subjected to a varying magnetic field. As easily understood from FIG. 8A, the electromotive force induced in the outermost coil 321 when the capturing element 1 inclines in one direction will be opposed to the electromotive force induced in the innermost coil 322 at the same time, but due to the way in which the coils are interconnected (as discussed above; cf. also FIG. 8C), the generated current will correspond to the sum of the electromotive forces induced in the two coils. FIGS. 8B and 8D schematically illustrate the distribution of the magnets of FIG. 8A, and FIG. 8C schematically illustrates the arrangement of the coils. FIG. 8E schematically illustrates an alternative arrangement in which ferromagnetic material 360 has been added to conduct the field lines in a suitable manner.

Additionally, further annular magnets 41 are provided on the fixed subsystem support, namely, on the projection 23. As understood from FIG. 8A, due to their orientation, there is a repulsive force between these magnets 41 and the magnets 311 attached to the capturing element, and this repulsive force increases when the magnets approach each other during the oscillating movement, as explained above. Thus, these magnets can serve to constitute a passive system for adaptation of the natural frequency of oscillation of the capturing element to the wind speed, as explained above. More specifically, when the capturing element 1 oscillates in relation to the base, a portion of the annular magnet 311 mounted on the capturing element approaches a portion of the annular magnet 41 mounted on the subsystem support 2, while on the diametrically opposite side of the capturing element, a portion of the magnet 311 moves away from the corresponding portion of the magnet 41. The repulsion force between the magnets 311 and 41 is inversely proportional to the square of the distance between the magnets 311 and 41. When the wind increases, the amplitude of the oscillatory movement of the capturing element tends to increase, whereby the magnets 311 and 41 tend to get closer and closer during the part of maximum approach of each oscillation cycle and therefore, the maximum repulsion force produced between the magnets 311 and 41 in each oscillation cycle increases accordingly. The increase of this repulsion force increases the resonance frequency of the structure. In this way, the very structure of the generator of FIG. 8A, with its magnets 311 and 41, contributes to an automatic increase in the resonance frequency of the capturing element 1 when the wind speed increases and vice versa. In this way, by properly selecting and arranging the magnets 311 and 41, something that can be done by trial and error tests and/or by computer simulations, the automatic adjustment of the natural oscillation frequency of the capturing element to wind speed can be achieved, such that it is always tuned with the frequency of appearance of vortices, thereby achieving a good uptake of energy from the movement of the fluid. In other words, a function of the magnets 311 and 41 may be to obtain the automatic tuning between the natural oscillation frequency of the capturing element and the frequency of appearance of vortices.

For example, both the capturing element 1 and the subsystem support 2 are provided with magnets, for example, in the shape of magnetic rings or sets of individual magnets arranged in the shape of a ring, arranged coaxially and in such a way that the magnets tend to repel each other. Thereby, the oscillating movement of the capturing element is not only influenced by the vortices but also by the magnetic forces, so that the natural oscillation frequency of the capturing element increases as the amplitude of oscillation increases.

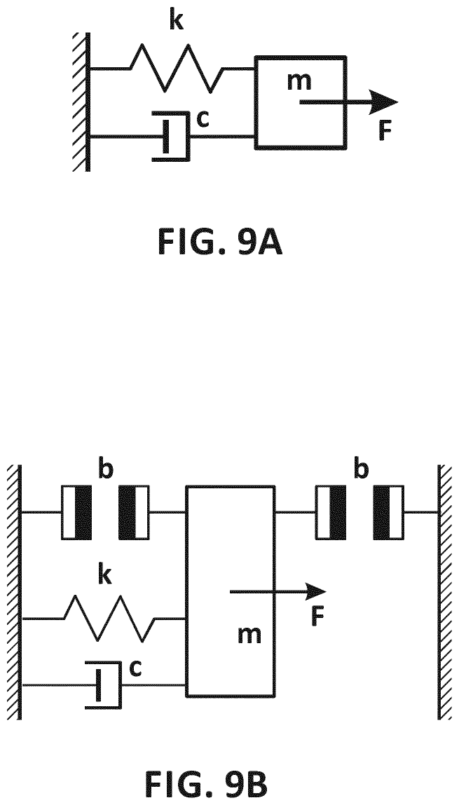

As follows from what has been explained above, the subsystem support and the part of the subsystem that is arranged on it has a function corresponding to that of the stator of a non-conventional alternator designed to produce energy without the use of any bearing or reduction gearbox and that can produce power regardless of the direction in which the rod 5 is flexed. A large number of rows of coils and magnets such as those of FIGS. 8A-8E can be provided, whereby the magnets 41 contribute both to the production of power and to the “auto-tuning” of the generator to wind speed. FIGS. 9A and 9B illustrate schematically the behaviour of a capturing element without any tuning system (FIG. 9A) and the behaviour of a capturing element with the tuning system according to a possible embodiment of the invention (FIG. 9B).

The object of the tuning mechanism is to modify the natural oscillation frequency of the equipment according to the speed of the fluid. When the device has no tuning system its movement can be modelled as the one of a damped simple harmonic oscillator (a) (FIG. 9A):

m·\ddot{x}+c·\dot{x}+k·x=0 a)

where m is its mass, c is the damping constant including the structural damping of the device itself, other losses and the mechanical energy converted into electrical energy and k is the elasticity constant of the elastic rod. In this case, the natural oscillation frequency of the equipment is:

$${w}_{0} = \sqrt{\frac{k}{m}} \qquad b )$$

When, given the generation of vortices, the capturing element is affected by the sinusoidal force F with maximum value F₀ (proportional to the square of the frequency if the value of the lift coefficient is considered constant), a delay in φ and frequency w=2·π·f(w[rad/s], f[Hz]), the movement can be modelled as the one of a forced damped harmonic oscillator:

m·\ddot{x}+c·\dot{x}+k·x=F=F₀·cos(wt+φ) c)

When the frequency w coincides with the natural frequency of the equipment w₀, the latter enters in resonance and experiences a remarkable increase in its ability to absorb energy from the fluid.

As the frequency w is proportional to the speed of the fluid, in principle, given that the device has only one natural oscillation frequency (in the first oscillation mode), there will only be one single speed at which the device would work. However, the profit that can be obtained by for example a wind power generator is related to the number of hours/year during which the generator is running, producing electrical power. As explained above, there is a small range of wind speeds (the aerodynamic phenomenon of lock-in) in which an equipment based on the Karman vortices can maintain its resonance, but this is far smaller than desirable for a reasonably competitive generator.

In order to be able to increase this range of wind speeds, a tuning mechanism can be incorporated that modifies the oscillation frequency of the device. Thus, the capturing element will oscillate at greater frequency in the presence of higher wind speed, or in other words, in the presence of an increase in the frequency of appearance of vortices.

The arrangement of FIG. 9B differs from that of FIG. 9A by the addition of two pairs of magnets in repulsion mode. The movement of this model can be described by the following expression:

$$m \cdot \ddot{x} + c \cdot \dot{x} + k \cdot x + \frac{b}{{( d - x )}^{2}} - \frac{b}{{( d + x )}^{2}} = F \qquad d )$$

where b would include (the Coulomb law for magnetism), the inverse of the magnetic permeability and the product of the magnetic masses, d is the distance at rest between each pair of magnets.

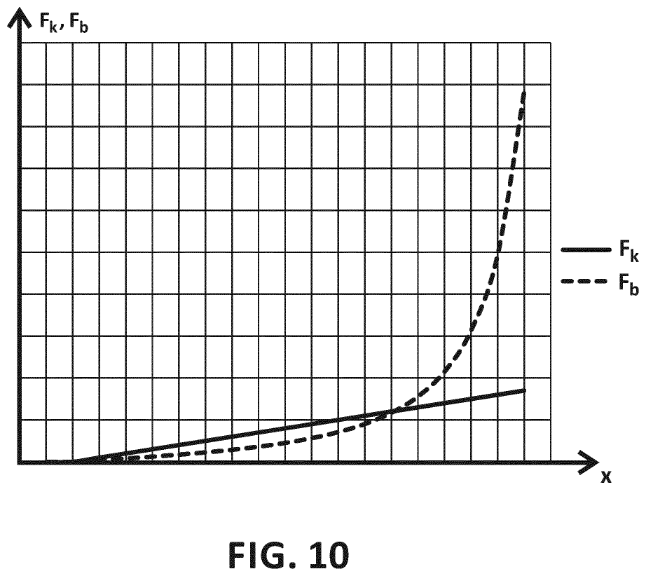

As shown in FIG. 10, the evolution with the displacement x of the spring force Fₖ produced on the mass by deformation of the rod and the joint force produced by the two pairs of magnets F_{b} are very different. As it can be seen and as already mentioned, as the mass (the capturing element) moves, near its neutral position of zero bending the spring force is predominant against the magnetic forces. As the displacement increases, its influence begins to equalise and in high displacements, the predominant force is of magnetic origin.

This has several implications.

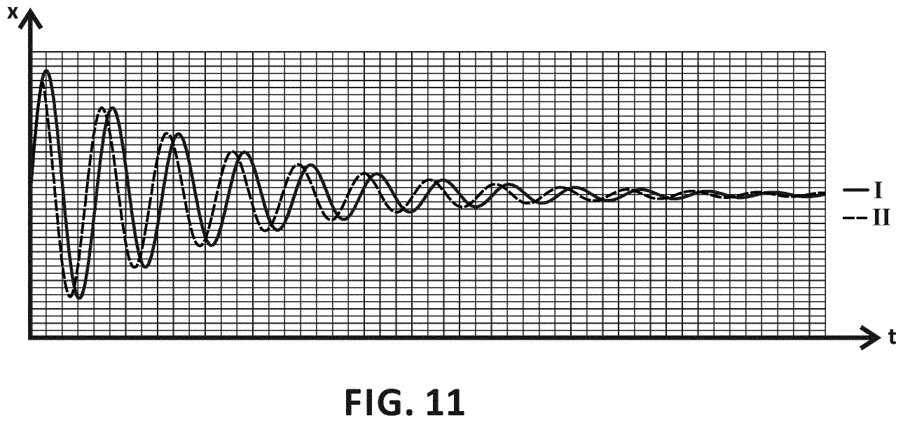

The kinetic energy of the oscillating capturing element when it passes through its neutral position of zero bending depends in both cases on the square of its mass and its speed. Not so with the stored potential energy when its displacement is maximum. In the case represented in FIG. 9A, the potential energy is only elastic potential energy and in the case represented in FIG. 9B, the potential energy will have both an elastic and a magnetic nature with the difference that the potential energy of magnetic origin increases with the cube of the displacement and not with the square. As shown in FIG. 10, in comparison with the damped simple harmonic movement (I) for large displacements, the trajectory of the movement with magnetic repulsion (II) suffers an increase in its frequency of oscillation. With small displacements (on the right side of the graph), where almost all the potential energy is accumulated by the elastic rod, both trajectories have a very similar size period. FIG. 11 schematically illustrates the variation over time of the amplitude (displacement x) and frequency (oscillation along the time axis t) of a device without tuning (I) and a tuned device (II) (movement with magnetic repulsion) when subjected to the action of an instantaneous force in the initial instant.

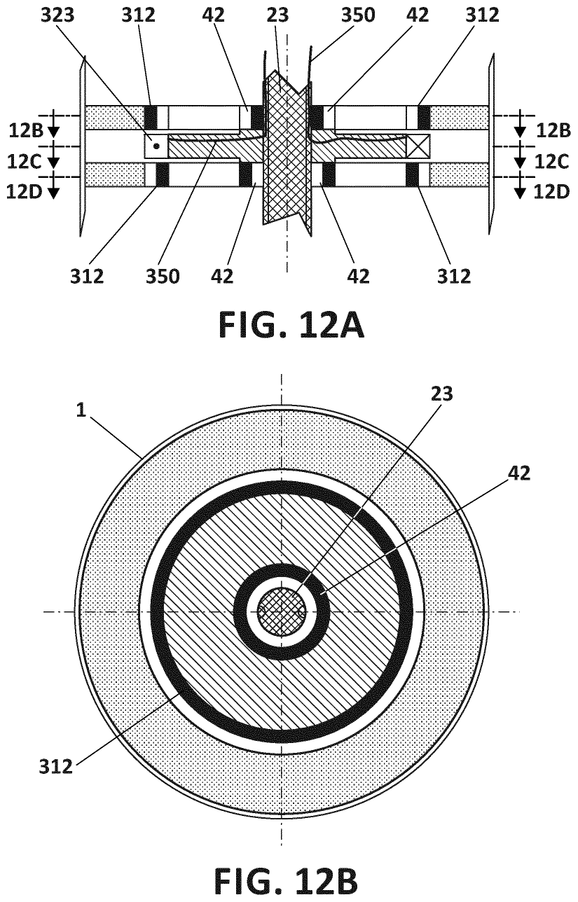

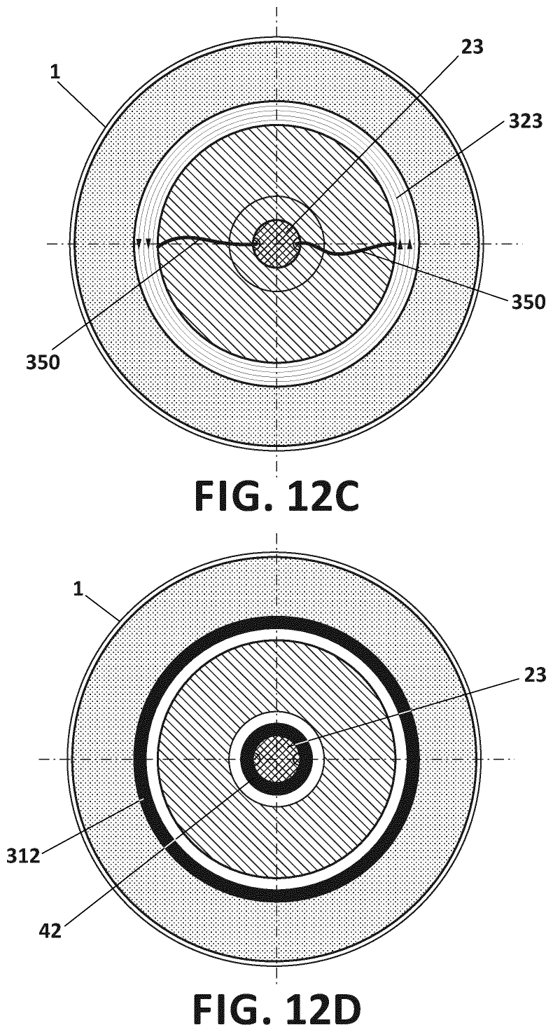

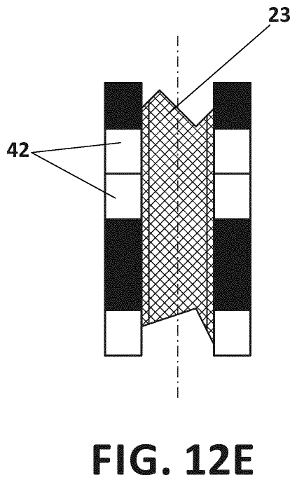

FIGS. 12A-12D are views analogous to the views of FIGS. 8A-8D, but of an embodiment featuring an alternative arrangement of magnets and coils. Here, the subsystem for converting the movement into electrical power comprises, at the illustrated level of the system, one coil 323. This coil is arranged between two annular magnets (in other embodiments, there can be more coils per level, and the subsystem can comprise multiple levels of coils 323 and magnets 312). In this embodiment, and differently from the arrangement of FIGS. 8A-8D, the annular magnets are arranged with their N pole and S pole arranged radially outwards or inwards, rather than up/down. It is clear from FIG. 12A how the oscillating movement will displace the magnets 312 radially, thereby inducing an electromotive force into the coil 323. Also in this embodiment magnets 42 are provided for “auto-tuning” the natural frequency of oscillation of the capturing element. In this case, these magnets 42 are likewise oriented with the N pole and S pole radially rather than vertically.

Regarding the annular magnets, such as magnets 42, in some embodiments these magnets are formed by several individual magnets arranged in a ring, but in other embodiments these magnets consist of a single ring-shaped magnet. In such cases, it has been found that it may be cheaper to obtain ring-shaped magnets with the N and S poles oriented in the axial direction (as in annular magnet 41 of FIG. 8A) rather than in the radial direction (as in the case of magnet 42 of FIG. 12A). Thus, in order to reduce the costs involved, one possibility can be to obtain a magnet with a radially oriented S (or N) pole by positioning one magnet with axially arranged poles on top of another one, as schematically illustrated in FIG. 12E.

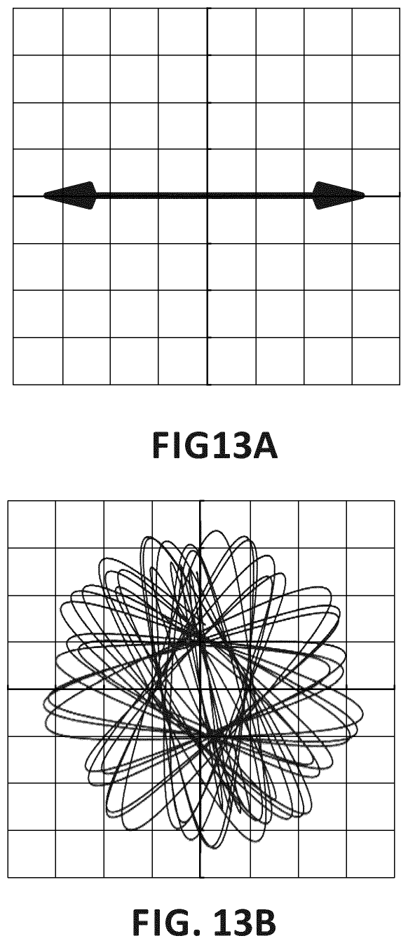

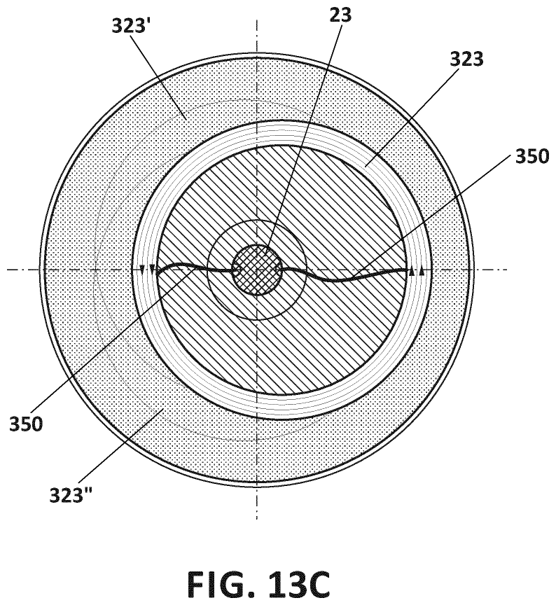

Theoretically, when the fluid moves in a constant direction, such as when the wind blows constantly in one direction, the projection of the oscillatory movement of the capturing element on the horizontal plane is linear, as shown in FIG. 13A. However, it has been observed that sometimes, and apparently especially when a magnetic auto-tuning arrangement as explained above is used, the capturing element will oscillate but not only in one vertical plane, but in an apparently randomized way, as schematically illustrated in FIG. 13B. That is, the movement when projected onto the horizontal plane is not only linear, but has also a rotational component.

Although it may be desirable to prevent the capturing element from oscillating as per FIG. 13B, it has been found that also in this kind of oscillation mode energy can be extracted from the movement. However, it has been found that in such cases and in order to optimise the extraction of electrical power when using coils arranged in the horizontal plane as per FIGS. 8A-8E or 12A-12D, it may be advantageous to arrange the coils so that their centres do not coincide with the longitudinal axis 2000 of the generator. This kind of arrangement is schematically illustrated in FIG. 13C, where the coil 323 is asymmetrically arranged in relation to the projection 23, that is, in relation to the longitudinal axis 2000 of the generator. Also, two further coils 323′ and 323″, arranged in other horizontal planes than the coil 323, are schematically suggested in FIG. 13C. These coils are axially displaced in relation to the coil 323, that is, they correspond to different “levels” of the subsystem for converting movement into electrical power. The centres of the coils 323′ and 323″ are also radially displaced in relation to the projection 23. The three coils 323, 323′ and 323″ are offset in different radial directions, with an angular spacing of 120°, as schematically illustrated in FIG. 13C.

On the other hand, for example as an alternative to the approach suggested above, a controlled injection or extraction of energy into/out of the subsystem(s) 3 for converting the oscillating movement of the capturing element into electrical energy can be used to keep the oscillation of the capturing element substantially in one vertical plane, that is, to prevent oscillation as per FIG. 13B.

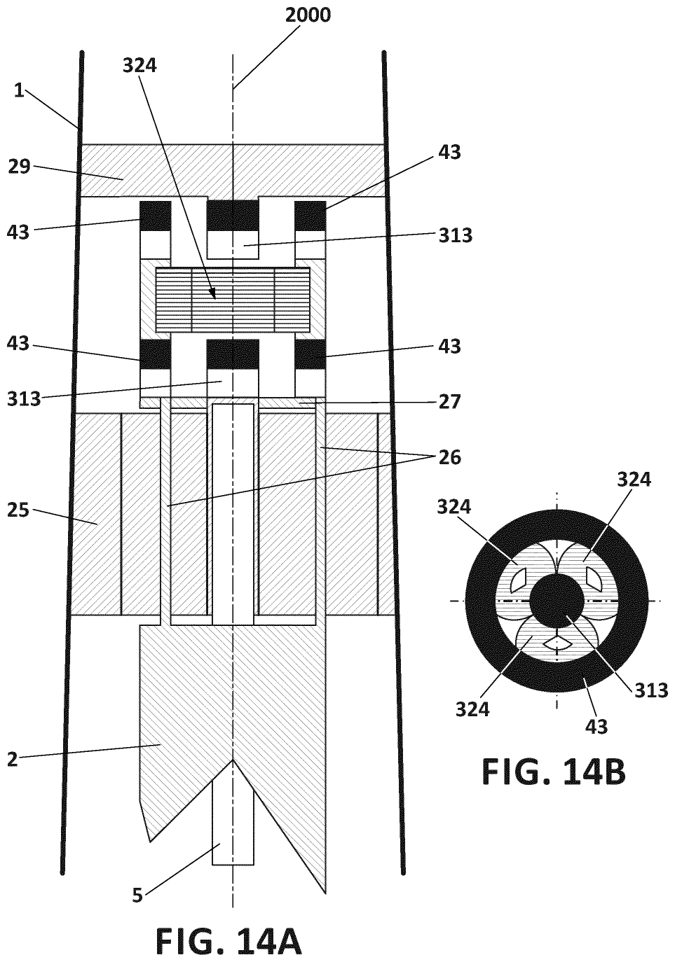

FIGS. 14A and 14B illustrate an alternative embodiment in which the subsystem comprises a plurality of coils 324 supported by the subsystem support 2, the coils being arranged substantially in the same plane and side by side, preferably symmetrically in relation to the longitudinal axis 2000, for example, as shown in FIG. 14B where three coils 324 are distributed symmetrically (at an angular spacing of 120 degrees) around the axis 2000. One or more pairs of magnets 313 are arranged to establish a magnetic field so that the relative movement between magnets and coils generates an electromotive force in the coils. In this embodiment, the magnets are attached to the capturing element and the coils are arranged on the subsystem support 2. This arrangement with a plurality of coils arranged “side by side” (rather than concentrically) around the longitudinal axis 2000 has been found to be efficient for converting the oscillating movement into electrical energy, for example, when the oscillation is not strictly limited to one vertical plane, which can often be the case when, as explained above, there is an interaction between magnets. Also in this embodiment, magnets 43 for tuning the natural frequency of oscillation of the capturing element are provided, that interact with the magnets 313 creating a repulsion force. The principles for this tuning have been described above.

In the embodiment of FIG. 14A, the capturing element 1 is attached to the rod member 5 by an interconnecting member 25 featuring through holes for the legs 26 of the subsystem support 2, as explained above, so that the capturing element can sway and oscillate without any interference with the subsystem support 2, through which the rod member 5 extends. In what regards the pair of magnets 313, one member of the pair is attached over the coils 324 by a bridge member 29 attached to the capturing element 5, whereas the other member of the pair of magnets 313 is attached to the end of the rod member 5 and, thus, indirectly attached to the capturing element. This allows the capturing element including the components physically attached to it to be implemented with a relatively low weight, which favours the amplitude of oscillation and a substantial lock-in range.

In the illustrated embodiment, the “tuning” magnets 43 comprise two annular magnets 43 placed on the subsystem support 2, on two axially opposite sides of the coils 324, facing the respective member of the pair of magnets 313 so as to provide the tuning of the natural frequency of oscillation according to the principles explained above.

In this text, the term “subsystem” in the expression “subsystem for converting the oscillating movement of the capturing element into electrical energy” or similar should not be interpreted in any limited sense. In the field of conventional wind turbines, the expression “generator” is frequently used for the part of the overall wind turbine that converts the mechanical or kinetic energy into electrical energy. In the present document, the term “generator” is used to denote the global system including the capturing element, that is, the part that interacts with the primary energy source, for example, the wind, to capture energy. In order to avoid confusion, the term “generator” has thus not been used for the subsystem for converting the oscillating movement of the capturing element into electrical energy. However, this subsystem can obviously be regarded as a generator, as it generates electrical energy. Also, the generator can comprise more than one subsystem for converting movement into electrical energy. If there are more than one subsystem, not all of the subsystems have to be arranged as described above.

In this text, the term “magnet” generally refers to a permanent magnet, although whenever appropriate also electromagnets may be used, as readily understood by the person skilled in the art.

In this text, the term “annular” when applied to magnets does not require that the magnet in question be a completely “annular” magnet made up of one single annular element. Rather, the term “annular” refers to the general configuration of the magnet, but not to its constitution. That is, an “annular magnet” in the context of the present document can be made up of a plurality of individual magnets, substantially arranged in a circle, with or without space between the individual magnets. The space can be substantial, as long as it does not deprive the set of magnets in question from forming a general circular configuration. The person skilled in the art will use components considering aspects such as cost of the components and cost of their installation. The same applies to references to a magnet shaped as a “ring”.

In this text, terms as “above”, “below”, “vertical”, “horizontal”, etc., generally refer to a situation in which the elongated capturing element is arranged with its first end below its second end, that is, generally, with a longitudinal axis of the capturing element extending vertically. However, this should not be interpreted to imply that the capturing element must always be arranged in this way. In some implementations, other orientations of the capturing element are possible.

In this text, the term “comprises” and its derivations (such as “comprising”, etc.) should not be understood in an excluding sense, that is, these terms should not be interpreted as excluding the possibility that what is described and defined may include further elements, steps, etc.

The invention is obviously not limited to the specific embodiment(s) described herein, but also encompasses any variations that may be considered by any person skilled in the art (for example, as regards the choice of materials, dimensions, components, configuration, etc.), within the general scope of the invention as defined in the claims.

1. An electrical power generator comprising:
a capturing element having an elongated shape, the capturing element extending in a longitudinal direction between a first end of the capturing element and a second end of the capturing element, wherein the capturing element has a length between the first end and the second end,
the capturing element being configured to be attached to a base and submerged in a fluid with the first end closer to the base than the second end, the capturing element being configured such that, when the fluid moves, the capturing element generates vortices in the fluid so that an oscillating lift force is generated on the capturing element, which produces an oscillating movement of the capturing element; and
a subsystem for converting the oscillating movement of the capturing element into electrical energy;
wherein the capturing element has a cross section with a characteristic dimension,
wherein the characteristic dimension decreases from a first longitudinal position located closer to the first end than to the second end until a second longitudinal position located closer to the second end than the first longitudinal position.

2. The electrical power generator according to claim 1, wherein the distance between the first longitudinal position and the second longitudinal position is greater than 30% of the length of the capturing element, such as greater than 80% of the length of the capturing element, such as 100% of the length of the capturing element.

3. The electrical power generator according to claim 1, wherein the distance between the first longitudinal position and the first end is less than 10% of the length of the capturing element.

4. The electrical power generator according to claim 1, wherein the capturing element has a substantially circular cross section, so that the cross section has a diameter, the characteristic dimension being the diameter.

5. The electrical power generator according to claim 1, wherein the capturing element has a cross section with a shape substantially as a regular polygon, with or without rounded vertices, wherein the characteristic dimension is the diameter of a circle which has the same surface area as the cross section of the capturing element.

6. The electrical power generator according to claim 1, wherein the capturing element comprises, between a cover point and the second end,
a first portion wherein the decrease rate is either constant or increases in the direction from the first end towards the second end, and
a second portion, which is closer to the second end than the first portion, wherein the decrease rate is
either constant and lower than the decrease rate at the first portion; or
decreases in the direction from the first end towards the second end.

7. The electrical power generator according to claim 6, wherein
the first portion has a frustoconical shape, the cross section being substantially circular and the decrease rate being constant, and
the second portion has a frustoconical or conical shape, the cross section being substantially circular and the decrease rate being constant but lower than the decrease rate in the first portion.

8. The electrical power generator according to claim 6, wherein the first portion is convex towards the exterior and the second portion is concave towards the exterior.

9. The electrical power generator according to claim 1, wherein the capturing element is at least partially hollow, and the subsystem is at least partially housed inside the capturing element.

10. The electrical power generator according to claim 9, wherein the subsystem is completely housed within the capturing element.

11. The electrical power generator according to claim 9, wherein the subsystem is placed at a distance of more than 0.05 times the length of the capturing element from the first end, such as at a distance of more than 0.3 times the length of the capturing element or more than 0.4 times the length of the capturing element from the first end, and optionally at a distance of at least 0.1 times the length of the capturing element from the second end, such as at a distance of more than 0.2 times the length of the capturing element or more than 0.3 times the length of the capturing element from the second end.

12. The electrical power generator according to claim 9, wherein the subsystem comprises at least one first subsystem component and at least one second subsystem component arranged for the production of electrical power by movement of the first subsystem component in relation to the second subsystem component, wherein the first subsystem component is attached to the capturing element (1) and the second subsystem component is attached to a subsystem support, so that the oscillating movement of the capturing element produces an oscillating movement of the first subsystem component in relation to the second subsystem component.

13. The electrical power generator according to claim 12, wherein at least one of the first subsystem component and the second subsystem component comprises at least one magnet, and wherein at least another one of the first subsystem component and the second subsystem component comprises at least one coil, arranged so that the oscillating movement of the first subsystem component in relation to the second subsystem component generates an electromotive force in the at least one coil by relative displacement between the at least one magnet and the at least one coil.

14. The electrical power generator according to claim 13, wherein the at least one coil comprises two coils arranged in a common plane and surrounding an axis of the capturing element, one of the coils being external to the other one of the coils, the two coils being connected in series so that when current circulates in a clockwise direction through one of the coils, current circulates in a counter-clockwise direction through the other one of the coils, and vice-versa.

15. The electrical power generator according to claim 9, wherein the subsystem comprises at least one annular magnet or at least one annular coil arranged in a plane perpendicular to a longitudinal axis of the capturing element, wherein said annular magnet or annular coil is asymmetrically positioned in relation to the longitudinal axis.

16. The electrical power generator according to claim 9, comprising means for generating a magnetic field that produces a magnetic repulsion force between the capturing element and a subsystem support, which varies with the oscillating movement of the capturing element and which has a maximum value that increases when the amplitude of the oscillating movement of the capturing element increases.

17. The electrical power generator of claim 16, wherein the means for generating a magnetic field comprises at least one first magnet associated to the capturing element and at least one second magnet associated to the subsystem support,
said at least one first magnet and said at least one second magnet being arranged in such a way that they repel each other and in such a way that when the oscillating movement of the capturing element takes place, the distance between the at least one first magnet and the at least one second magnet varies according to the oscillating movement.

18. The electrical power generator according to claim 16, wherein the capturing element is arranged so that the amplitude of the oscillating movement increases with the velocity of the fluid, at least within a certain range of velocities, wherein the repulsion force between the, at least one, first magnet and the, at least one, second magnet is inversely proportional to the square of the distance between the first magnet and the second magnet, and wherein, when the speed of the fluid increases, the amplitude of the oscillating movement tends to increase, whereby the magnets tend to get closer during a part of maximum approach of each oscillation cycle, whereby the maximum repulsion force produced between the, at least one, first magnet and the, at least one, second magnet in each oscillation cycle increases accordingly, whereby the increase of the repulsion force increases the resonance frequency of the capturing element, whereby the structure of the generator contributes to an automatic increase in the resonance frequency of the capturing element when the speed of the fluid increases, and vice-versa.

19. The electrical power generator according to claim 16, wherein the means for generating a magnetic field are placed at a distance of more than 0.05 times the length of the capturing element from the first end, such as at a distance of more than 0.3 times the length of the capturing element, from the first end, and optionally at a distance of at least 0.1 times the length of the capturing element from the second end, such as at a distance of more than 0.2 times the length of the capturing element or more than 0.3 times the length of the capturing element below the second end.

20. The electrical power generator according to claim 1, further comprising a support element which comprises a first attaching point and a second attaching point, wherein:
the first attaching point is a point of the support element where the electrical power generator is intended to be attached to the base;
the second attaching point is a point of the support element where the support element is attached to the capturing element.

21. The electrical power generator according to claim 20, wherein the capturing element is at least partially hollow, and the subsystem is at least partially housed inside the capturing element,
further comprising means for generating a magnetic field that produces a magnetic repulsion force between the capturing element and a subsystem support, which varies with the oscillating movement of the capturing element and which has a maximum value that increases when the amplitude of the oscillating movement of the capturing element increases,
wherein the means for generating a magnetic field comprises at least one first magnet associated to the capturing element and at least one second magnet associated to the subsystem support, said at least one first magnet and said at least one second magnet being arranged in such a way that they repel each other and in such a way that when the oscillating movement of the capturing element takes place, the distance between the at least one first magnet and the at least one second magnet varies according to the oscillating movement, wherein
at least one magnet forming part of the means for generating a magnetic field which produces a magnetic repulsion force between the capturing element and the support element, also forms part of the subsystem for converting the oscillating movement of the capturing element into electrical energy.

22. The electrical power generator according to claim 20, wherein the capturing element is configured to be attached to the base via a support element arranged to be repetitively deformed by the oscillating movement of the capturing element, wherein the support element extends into the capturing element, and wherein a subsystem support supporting at least part of the subsystem likewise extends into the capturing element.

23. The electrical power generator according to claim 20, wherein the support element is a rod member extending from the base and into the capturing element, and wherein the subsystem support extends into the capturing element to a position axially beyond the rod member.

24. The electrical power generator according to claim 20, suitable for being submerged in an airflow with a speed profile given by Hellmann's law, the size of the characteristic dimension being defined by the following formula:
$$\frac{D ( y )}{d} = {( 1 + \frac{y}{{y}_{0}} )}^{α} \cdot g ( y ) - {k}_{1} \cdot \frac{y}{H}$$
wherein
y₀ is the distance between the first attaching point and the first end;
α is the Hellmann's law coefficient, comprised between 0.05 and 0.3;
d is the value of the characteristic dimension at the first end of the capturing element;
y is the coordinate measured from the first end of the capturing element, in the direction towards the second end of the capturing element;
D(y) is the size of the characteristic dimension of the cross section of the capturing element;
g(y) is a sigmoid function;
H is the length of the capturing element; and
k₁ is a constant value depending on the oscillation amplitude of the capturing element.

25. The electrical power generator according to claim 24, wherein α is comprised between 0.05 and 0.18, y₀ is comprised between 0.2 and 2 metres, H is comprised between 2 and 5 times y₀ and k₁ is comprised between 0.325 and 0.5.

26. The electrical power generator according to claim 24, wherein
$$g ( y ) = \frac{1}{1 + {e}^{- τ}}$$
$$wherein$$
$$τ = \frac{\frac{2 K}{p} \cdot ( H - y )}{H - L / 2} - K$$
K>4, and p<0.3.

27. The electrical power generator according to claim 10, wherein the subsystem comprises:
a plurality of coils comprising at least three coils arranged side by side in a plane perpendicular to a longitudinal axis of the capturing element and preferably substantially symmetrically in relation to said longitudinal axis; and
at least one pair of magnets arranged to produce a magnetic field;
the coils and the magnets being arranged so that the oscillating movement of the capturing element produces a relative movement between the at least one pair of magnets and the coils so as to generate an electromotive force in the coils.

28. The electrical power generator according to claim 27, wherein the coils are attached to a subsystem support structure and wherein the pair of magnets are attached to the capturing element so as to oscillate with the capturing element.

29. The electrical power generator according to claim 27, further comprising additional magnets arranged in such a way that the additional magnets and the at least one pair of magnets repel each other and in such a way that when the oscillating movement of the capturing element takes place, the distance between the additional magnets and the at least one pair of magnets varies according to the oscillating movement.

30. The electrical power generator according to claim 27, wherein the plurality of coils consists of three coils situated around the longitudinal axis and having their axial centre portions spaced by approximately 120 degrees from the axial centre portions of the adjacent coils.

31. An electrical power generator comprising:
a capturing element having an elongated shape, the capturing element extending in a longitudinal direction between a first end of the capturing element and a second end of the capturing element, the capturing element being configured to be attached to a base and submerged in a fluid with the first end closer to the base than the second end, the capturing element being configured such that, when the fluid moves, the capturing element generates vortices in the fluid so that an oscillating lift force is generated on the capturing element, which produces an oscillating movement of the capturing element; and
a subsystem for converting the oscillating movement of the capturing element into electrical energy, the subsystem being at least partially housed inside the capturing element;
wherein the subsystem comprises:
a plurality of coils comprising at least three coils arranged side by side in a plane perpendicular to a longitudinal axis of the capturing element and preferably substantially symmetrically in relation to said longitudinal axis, and
at least one pair of magnets arranged to produce a magnetic field;
the coils and the magnets being arranged so that the oscillating movement of the capturing element produces a relative movement between the at least one pair of magnets and the coils so as to generate an electromotive force in the coils.

32. The electrical power generator according to claim 31, wherein the subsystem is completely housed within the capturing element.

33. The electrical power generator according to claim 31, wherein the capturing element has a length between the first end and the second end, wherein the subsystem is placed at a distance of more than 0.05 times the length of the capturing element from the first end, such as at a distance of more than 0.3 times the length of the capturing element or more than 0.4 times the length of the capturing element from the first end, and optionally at a distance of at least 0.1 times the length of the capturing element from the second end, such as at a distance of more than 0.2 times the length of the capturing element or more than 0.3 times the length of the capturing element from the second end.

34. The electrical power generator according to claim 31, wherein the capturing element is configured to be attached to the base via a support element arranged to be repetitively deformed by the oscillating movement of the capturing element, wherein the support element extends into the capturing element, and wherein a subsystem support supporting at least part of the subsystem likewise extends into the capturing element.

35. The electrical power generator according to claim 31, further comprising additional magnets arranged in such a way that the additional magnets and the at least one pair of magnets repel each other, and in such a way that when the oscillating movement of the capturing element takes place, the distance between the additional magnets and the at least one pair of magnets varies according to the oscillating movement.

36. The electrical power generator according to claim 1, wherein the capturing element is shaped for generation of von Karman vortices in a substantially synchronised manner along the capturing element.

37. A method of producing electrical power with an electrical power generator according to claim 1, comprising the step of subjecting the capturing element to a moving fluid such that the capturing element is caused to oscillate due to von Karman vortices induced in the fluid by the capturing element, whereby the von Karman vortices are generated in a substantially synchronized manner along the capturing element.
